(19) United States
(12) Patent Application Publication
(10) Pub. No.: US 2005/0053035 A1
(43) Pub. Date: Mar. 10, 2005

(54) Method and apparatus for providing uplink packet data service on uplink dedicated channels in an asynchronous wideband code division multiple access communication system

(75) Inventors: Yong-Jun Kwak, Yongin-si (KR); Ju-Ho Lee, Suwon-si (KR); Sung-Ho Choi, Suwon-si (KR); Young-Bum Kim, Seoul (KR); Youn-Hyoung Heo, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/918,948

(22) Filed: Aug. 16, 2004

(30) Foreign Application Priority Data
Aug. 16, 2003 (KR) 2003-56731
Aug. 20, 2003 (KR) 2003-57698
Aug. 20, 2003 (KR) 2003-58903

(51) Int. Cl. H04B 7/216

(52) U.S. Cl. 370/331; 370/320; 370/342; 370/335; 370/441; 370/464; 370/537

(57) ABSTRACT

An apparatus and method of using an E-DCH and an uplink DCH in an asynchronous WCDMA communication system. To determine an uplink channel status for using the DCH and E-DCH, a UE determines whether it is in a soft handover (SHO) region referring to active set information received from an RNC. If it is in a non-SHO region, the UE code-multiplexes the DCH and E-DCH. If it is in an SHO region, the UE time-multiplexes the DCH and E-DCH. A Node B analyzes uplink channel status information about the UE received form the RNC. If the UE is in a non-SHO region, the Node B code-demultiplexes the DCH and E-DCH received from the UE. If the UE is in an SHO region, the Node B time-multiplexes the DCH and E-DCH. For the multiplexing of the DCH and E-DCH, common TFS-related information is configured for the DCH and E-DCH.

### PRIORITY

This application claims priority under 35 U.S.C. § 119 to applications entitled “Method and Apparatus for Providing Uplink Packet Data Service on Uplink Dedicated Channels in an Asynchronous Wideband Code Division Multiple Access Communication System” filed in the Korean Intellectual Property Office on Aug. 16, 2003 and assigned Serial No. 2003-56731, filed in the Korean Intellectual Property Office on Aug. 20, 2003 and assigned Serial No. 2003-57698, and filed in the Korean Intellectual Property Office on Aug. 20, 2003 and assigned Serial No. 2003-58903, the contents of all of which are incorporated herein by reference.

### BACKGROUND OF THE INVENTION

1. Field of the Invention

The present invention relates generally to an asynchronous WCDMA (Wideband Code Division Multiple Access) mobile communication system, and in particular, to a method and apparatus utilizing uplink dedicated channels from a UE (User Equipment) to provide an uplink packet data service.

2. Description of the Related Art

UMTS (Universal Mobile Telecommunication Service), one of the 3^{rd} generation mobile communication systems, is based on GSM (Global System for Mobile communication) and GPRS (General Packet Radio Services). The UMTS system provides a uniform service that transmits packetized text, digital voice and video, and multimedia data at at least a 2 Mbps rate to mobile subscribers. With the introduction of the concept of virtual access, UMTS enables access to any end point in a network all the time. The virtual access refers to packet-switched access using a packet protocol such as an IP (Internet Protocol).

FIG. 1 illustrates a UTRAN (UMTS Terrestrial Radio Access Network). Referring to FIG. 1, a UTRAN 12 includes RNCs (Radio Network Controllers) 16a and 16b and a plurality of Node Bs 18a, 18b, 18c, and 18d. The UTRAN 12 connects a UE 20 to a core network (CN) 10. A plurality of cells may underlie the Node Bs 18a to 18d. The RNC 16a controls the Node Bs 18a and 18b, and the RNC 16b controls the Node Bs 18c and 18d. The Node Bs 18a to 18d control their underlying cells. An RNC, and Node Bs and cells under the control of the RNC, are collectively called an RNS (Radio Network Subsystem).

The RNCs 16a and 16b assign or manage the radio resources of the Node Bs 18a to 18d within their coverage areas. The Node Bs 18a to 18d provide radio resources. Radio resources are configured on a cell basis, and the radio resources provided by the Node Bs 18a to 18d are the radio cells of their managed cells. The UE 20 establishes a radio channel using radio resources provided by a particular cell, under a particular Node B, and communicates on the radio channel. From the UE's perspective, differentiation between a Node B and a cell is meaningless. The UE 20 only recognizes physical channels established on a cell basis. Therefore, the terms Node B and cell are interchangeably used herein.

A Uu interface is defined between a UE and an RNC. The hierarchical protocol architecture of the Uu interface is illustrated in detail in FIG. 2. The Uu interface is separated into a control plane (C-plane) for exchanging control signals between the UE and the UTRAN, and a user plane (U-plane) for transmitting actual data.

Referring to FIG. 2, C-plane signaling 30 is processed through an RRC (Radio Resource Control) layer 34, an RLC (Radio Link Control) layer 40, a MAC (Medium Access Control) layer 42, and a PHY (PHYsical) layer 44. U-plane information 32 is processed through a PDCP (Packet Data Control Protocol) layer 36, a BMC (Broadcast/Multicast Control) layer 38, the RLC layer 40, the MAC layer 42, and the PHY layer 44. The PHY layer 44 is defined in each cell, and the MAC layer 42 through the RRC layer 34 are defined in each RNC.

The PHY layer 44 provides an information delivery service by a radio transfer technology, corresponding to layer 1 (L1) in an OSI (Open Systems Interconnection) model. The PHY layer 44 is connected to the MAC layer 42 via transport channels. The mapping relationship between the transport channels and physical channels is determined according to how data is processed in the PHY layer 44.

The MAC layer 42 is connected to the RLC layer 40 via logical channels. The MAC layer 42 delivers data received from the RLC layer 40 to the PHY layer 44 on appropriate transport channels, and delivers data received from the PHY layer 44 on transport channels to the RLC layer 40 on appropriate logical channels. The MAC layer 42 inserts additional information into data received on logical channels or transport channels, or performs an appropriate operation by interpreting inserted additional information, and controls random access. A U-plane-related part is called MAC_d and a C-plane-related part is called MAC-c in the MAC layer 42.

The RLC layer 40 controls the establishment and release of the logical channels. The RLC layer 40 operates in one of an acknowledged mode (AM), an unacknowledged mode (UM), and a transparent mode (TM), and provides different functionalities in those modes. Typically, the RLC layer 40 segments or concatenates SDUs (Service Data Units) received from an upper layer to an appropriate size and corrects errors by ARQ (Automatic Repeat request).

The PDCP layer 36 is an upper layer when compared to the RLC layer 40 on the U-plane. The PDCP layer 36 is responsible for compression and decompression of the header of data in the form of an IP packet and lossless data delivery when an RNC providing service to a particular UE is changed due to the UE's mobility.

The RRC layer 34 is an upper layer when compared to the RLC layer 40 on the C-plane. The RRC layer 34 is responsible for the establishment/reestablishment/release of radio bearers between a UTRAN and UEs. The RRC layer 34 uses RRC messages to exchange establishment information required to manage the radio resources. The RRC message may include control messages transmitted from the CN by an NAS (Non-Access Stratum) protocol.

The characteristics of the transport channels that connect the PHY layer 44 to the upper layers depend on a TF (Transport Format) that defines PHY layer processing involving convolutional channel encoding, interleaving, and service-specific rate matching.

The UMTS system uses an E-DCH or EUDCH (Enhanced Uplink Dedicated Channel) to more efficiently transmit packet data from UEs on the uplink. To better support high-speed data transmission than a DCH (Dedicated Channel) used for general data transmission, the E-DCH utilizes AMC (Adaptive Modulation and Coding), HARQ (Hybrid Automatic Retransmission request), and Node B controlled scheduling.

FIG. 3 conceptually illustrates data transmission on the E-DCH via radio links. Referring to FIG. 3, reference numeral 100 denotes a Node B supporting the E-DCH and reference numerals 101 to 104 denote UEs that transmit the E-DCH. The Node B 100 detects the channel statuses of the UEs 101 to 104 using the E_DCH and schedules their uplink data transmission based on the channel statuses. The scheduling is performed such that a noise rise measurement does not exceed a target noise rise in the Node B, in order to increase the total system performance. Therefore, the Node B 100 assigns a low data rate to a remote UE 104, i.e., a UE that is farther away, and a high data rate to a nearby UE 101.

FIG. 4 is a diagram illustrating a signal flow for E-DCH transmission and reception. Referring to FIG. 4, a Node B and a UE establish an E-DCH in step 202. Step 202 involves transmitting messages on dedicated transport channels. The UE transmits scheduling information to the Node B in step 204. The scheduling information may contain uplink channel information, that is, the transmit power and power margin of the UE, and the amount of buffered data to transmit to the Node B.

In step 206, the Node B monitors the scheduling information to determine possible data transmission timing and a possible data rate for the UE. The Node B enables the UE to transmit uplink packets and transmits scheduling assignment information to the UE in step 208. The scheduling assignment information includes the allowed data rate and timing.

The UE determines the TF of the E-DCH based on the scheduling assignment information in step 210. In steps 212 and 214, the UE notifies the Node B of the TF and simultaneously transmits uplink packet data on the E-DCH. The uplink packet data is transmitted on an EU-DPDCH (Dedicated Physical Data Channel for E-DCH) to which the E-DCH is mapped, while the TF information is on an EU-DPCCH (Dedicated Physical Control Channel for E-DCH).

In step 216, the Node B determines if the TF information and the packet data have errors. In the presence of errors, the Node B transmits an NACK (Non-Acknowledgement) signal to the UE in step 216. However, in the absence of errors, the Node B transmits an ACK (Acknowledgement) signal to the UE in step 216.

In the latter case, the packet data transmission is completed and the UE transmits new packet data to the Node B on the E-DCH. However, in the former case, the UE retransmits the same packet data to the Node B on the E-DCH.

The E-DCH is a technology proposed in order to maximize the performance of uplink packet transmission by introducing an additional functionality to the existing DCH. Nonetheless, if E-DCH establishment information and DCH establishment information are separately determined, the UE and the Node B must modify the PHY layer structure for switching between the E-DCH and the DCH, or configure an additional PHY layer structure for multiplexing the E-DCH and the DCH. Therefore, there is a need for an effective technique for utilizing the E-DCH and the DCH together in the PHY layer, without increasing constraints on the UE and the Node B.

### SUMMARY OF THE INVENTION

The present invention has been designed to substantially solve at least the above problems and/or disadvantages and to provide at least the advantages below. Accordingly, an object of the present invention is to provide a method and apparatus for sharing the same establishment information between the E-DCH and the DCH in an asynchronous WCDMA communication system.

Another object of the present invention is to provide a method and apparatus for selectively multiplexing the E-DCH and the DCH in an asynchronous WCDMA communication system.

The above and other objects are achieved by providing a method utilizing an E-DCH and an uplink DCH in an asynchronous WCDMA communication system.

According to one aspect of the present invention, in a method of multiplexing a first dedicated channel and a second dedicated channel for an uplink packet data service, the second dedicated channel being enhanced from the first dedicated channel, in an asynchronous WCDMA communication system, an uplink channel status is determined in which the first and second dedicated channels are used, a physical layer code-multiplexing structure is configured for code-multiplexing the first and second dedicated channel in a user equipment (UE) that implements the uplink packet data service, if the uplink channel status is good, and a physical layer time-multiplexing structure is configured for time-multiplexing the first and second dedicated channel in the UE, if the uplink channel status is bad.

According to another aspect of the present invention, in a method of establishing a first dedicated channel and a second dedicated channel for an uplink packet data service, the second dedicated channel being enhanced from the first dedicated channel, in an asynchronous WCDMA communication system, common TFS-related information is configured which indicates TFs available to transport blocks transmitted on the first and second dedicated channels, and the TFS-related information is provided to a UE that implements the uplink packet data service, and at least one Node B.

According to a further aspect of the present invention, in a HARQ method for a second dedicated channel in an asynchronous WCDMA communication system in which a first dedicated channel and the second dedicated channel are used for an uplink packet data service, the second dedicated channel being enhanced from the first dedicated channel, data and error signals are received from at least two Node Bs communicating with a UE that implements the uplink data service by a soft handover. The data is produced by demodulating a signal received from the UE, the error signals indicate if the data has errors, and the at least two Node Bs include at least one legacy Node B not supporting the second dedicated channel and at least one enhanced Node B supporting the second dedicated channel. A response signal is determined according to the error signals and transmitted to the at least one enhanced Node B.

### BRIEF DESCRIPTION OF THE DRAWINGS

The above and other objects, features, and advantages of the present invention will become more apparent from the following detailed description when taken in conjunction with the accompanying drawings in which:

FIG. 1 illustrates a UTRAN in a UMTS system;

FIG. 2 illustrates a hierarchical protocol architecture of a radio interface between an RNC and a UE;

FIG. 3 conceptually illustrates conventional E-DCH data transmission via a radio link;

FIG. 4 is a diagram illustrating a signal flow for data transmission/reception on an E-DCH;

FIG. 5 illustrates a hierarchical transmission structure for code multiplexing of the E-DCH and a DCH;

FIG. 6 illustrates a hierarchical transmission structure for time multiplexing of the E-DCH and the DCH;

FIG. 7 is a diagram illustrating a signal flow for initially establishing the DCH;

FIG. 8 is a detailed flowchart illustrating an operation for configuring the TFs of the uplink DCH to initially establish the DCH;

FIG. 9 illustrates the format of an NBAP (Node B Application Part) message, Radio Link Setup Request that an SRNC transmits to a Node B;

FIG. 10 illustrates the format of an RRC message, Radio Bearer Setup that the SRNC transmits to a UE;

FIG. 11 illustrates the structure of transport blocks transmitted via a radio interface;

FIG. 12 illustrates a hierarchical structure for transmitting data units on an uplink DCH from the UE to the Node B;

FIG. 13 illustrates an operation for time-multiplexing the DCH and the E-DCH in a PHY layer according to a preferred embodiment of the present invention;

FIG. 14 illustrates the relationship between data blocks in protocol layers according to an embodiment of the present invention;

FIG. 15 is a diagram illustrating a signal flow for establishing the E-DCH according to an embodiment of the present invention;

FIG. 16 is a flowchart illustrating an operation for configuring the TFCS of the DCH and the E-DCH in the SRNC according to an embodiment of the present invention;

FIG. 17 illustrates the relationship between data blocks in protocol layers according to an embodiment of the present invention;

FIG. 18 illustrates the relationship between data blocks in protocol layers according to an embodiment of the present invention;

FIG. 19 illustrates a UE in a soft handover (SHO) region;

FIG. 20 is a diagram illustrating a signal flow for selective multiplexing of the E-DCH and the DCH according to a preferred embodiment of the present invention;
FIG. 21 is a block diagram of a transmitter for selective multiplexing in the UE according to the preferred embodiment of the present invention;

FIG. 22 is a block diagram of a receiver for selective demultiplexing in the Node B according to the preferred embodiment of the present invention;

FIG. 23 illustrates a HARQ operation between an RNC and Node Bs communicating with one UE at an SHO according to the preferred embodiment of the present invention;

FIG. 24 conceptually illustrates the operation of a UE using the E-DCH in an SHO region between a legacy Node B and an enhanced Node B according to the preferred embodiment of the present invention; and

FIG. 25 is a flowchart illustrating an operation of an SRNC for supporting HARQ according to the preferred embodiment of the present invention.

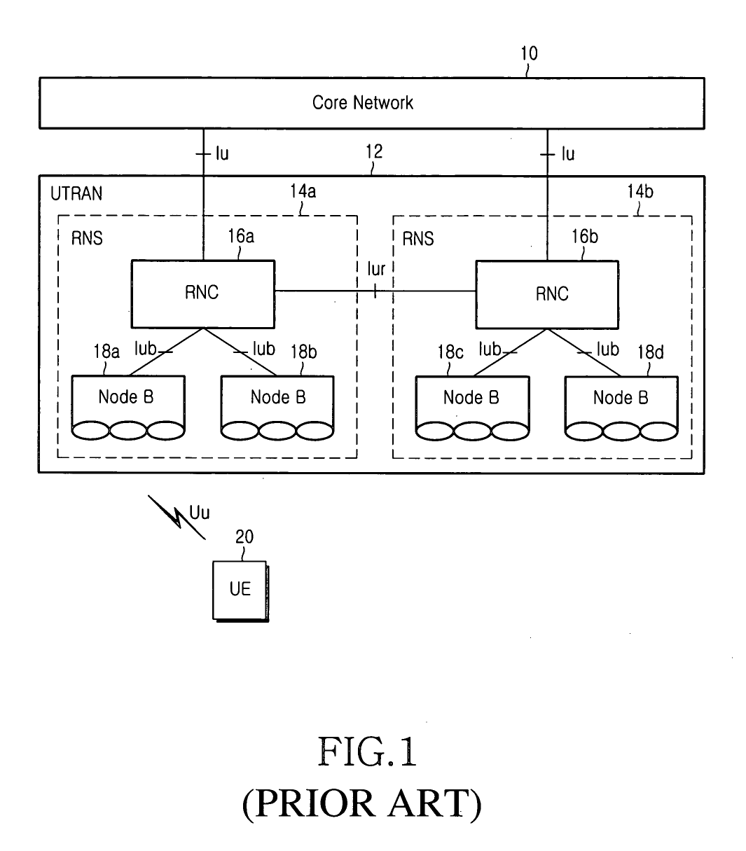

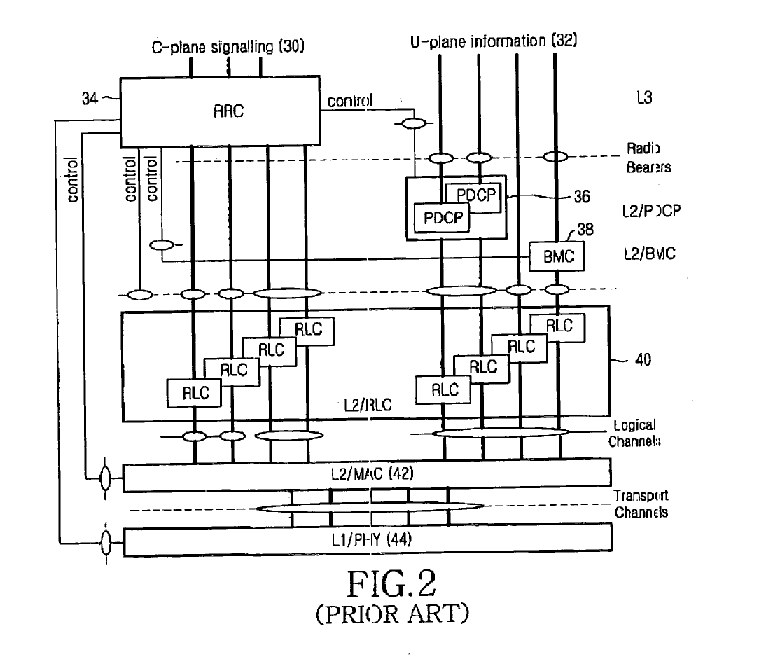

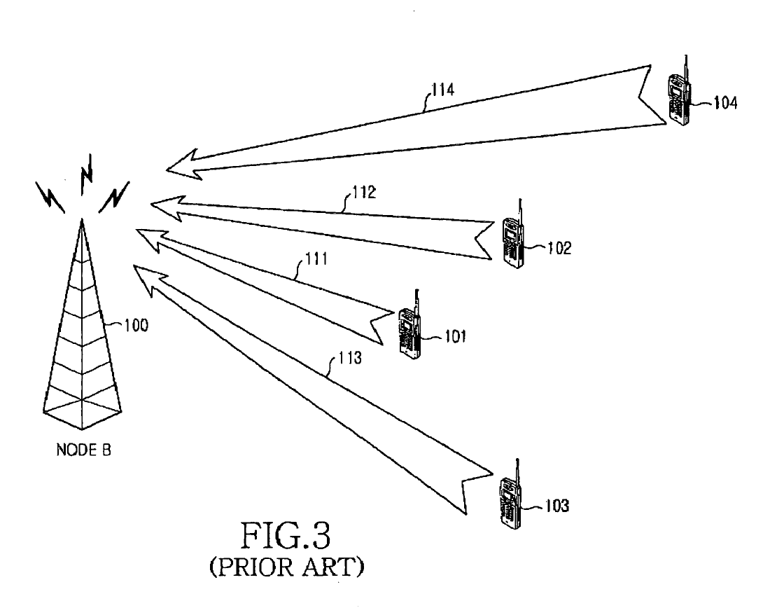

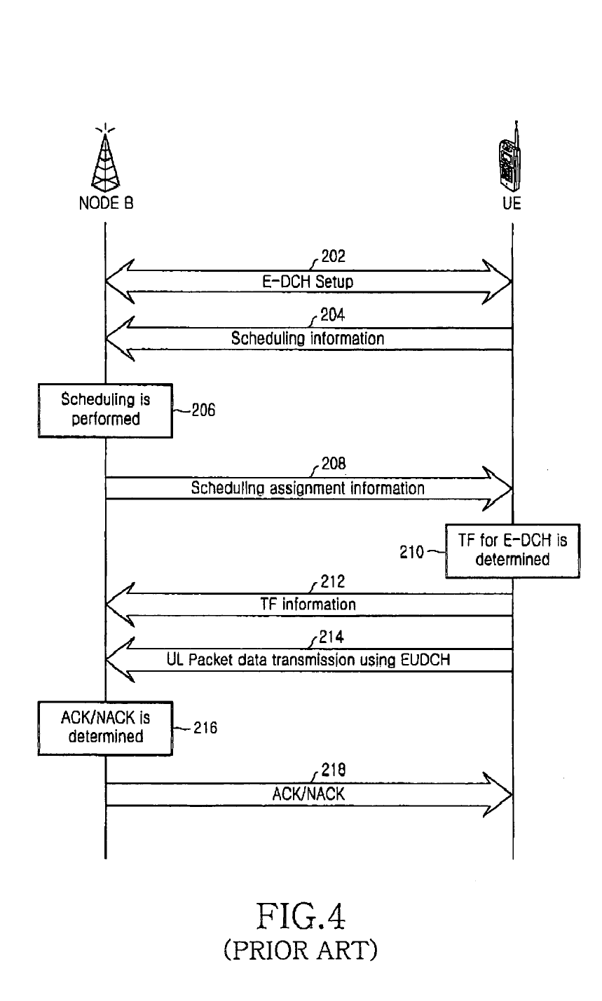

### DETAILED DESCRIPTION OF THE PREFERRED EMBODIMENTS

Preferred embodiments of the present invention will be described herein below with reference to the accompanying drawings. In the following description, well-known functions or constructions are not described in detail because they would obscure the invention in unnecessary detail.

The present invention provides a method of utilizing the E-DCH and the conventional DCH in an asynchronous WCDMA communication system. The E-DCH supports additional functionalities including AMC, HARQ, and Node B controlled scheduling in order to improve packet transmission performance. Specifically, common establishment information is set for the E-DCH and the DCH and transmitted to a Node B and a UE in the present invention.

In an uplink packet data service, the UE transmits uplink packet data to the Node B on either of the E-DCH and the DCH or both. When the UE uses both the E-DCH and the DCH, their multiplexing can be considered as either code multiplexing or time multiplexing.

The code multiplexing is a scheme of encoding the DCH and the E-DCH separately, creating individual CCTrCHs (Coded Composite Transport Channels) out of the coded DCH and E-DCH, and mapping the CCTrCHs to different physical channels (i.e., different code channels). Because the DCH and the E-DCH are transmitted separately, they have different TFs.

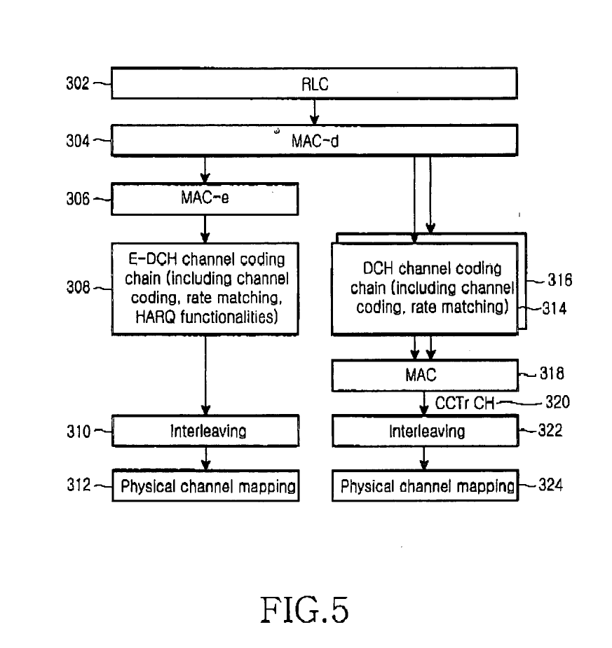

FIG. 5 illustrates a hierarchical architecture for code-multiplexing the E-DCH and the DCH. Referring to FIG. 5, a MAC-d layer 304 for processing the DCH generates a new data unit by attaching a predetermined header to data received from an overlying RLC layer 302, and transmits the new data unit to a PHY layer. The data from the MAC-d layer 304 is separated for respective transport channels, transferred to corresponding physical layer entities, and subject to encoding, separately.

In the case illustrated in FIG. 5, two transport channels are used. First and second channel data is respectively encoded through channel coding chains 314 and 316 of the PHY layer. Although not shown in detail, the channel coding chains 314 and 316 perform CRC (Cyclic Redundancy Code) attachment, channel encoding, interleaving, and rate matching. The coded data is time-multiplexed to one data block in a transport channel multiplexer (MUX) 318. The multiplexed data block is mapped to one CCTrCH. That is, DCH data transmitted on different transport channels is multiplexed to one composite channel through time multiplexing in the PHY layer.

The multiplexed CCTrCH data is transmitted wirelessly on a code channel though an interleaver 322 and a physical channel mapper 324. The physical channel mapper 324 maps the data of the transport channels to a corresponding code channel. If the CCTRCH data is too large to be mapped to one code channel, a plurality of code channels are used.

E-DCH data is also transferred from the RLC layer 302 through the MAC-d layer 304. Unlike the DCH, the E-DCH data is delivered to a MAC layer for processing the E-DCH between the MAC-d layer 304 and the PHY layer. This MAC layer is called a MAC-e layer 306. That is, the E-DCH data is transferred to the PHY layer via the RLC layer 302, the MAC-d layer 304, and the MAC-e layer 306.

While the E-DCH data can also be classified into a plurality of transport channels in the MAC-d layer 304 and the MAC-e layer 306, only one transport channel is illustrated for the E-DCH data herein. In the PHY layer, the E-DCH data is encoded in a channel coding chain 308. The channel coding chain 308 has the HARQ functionality in addition to the functionalities of the channel coding channels 314 and 361 of the DCH.

The coded E-DCH data is transmitted wirelessly on a code channel through an interleaver 310 and a physical channel mapper 312. The E-DCH data is delivered on a physical channel, which is different from that of the DCH data. One or more code channels can be used for the E-DCH data according to its data amount.

The above-described code multiplexing scheme has a simple transmission/reception structure and more efficient transmission due to the use of different TFs for the E-DCH and the DCH. However, the use of an additional spreading code increases a PAPR (Peak-to-Average Power Ratio).

The time multiplexing is a scheme for encoding the E-DCH and the DCH separately, time-multiplexing them to one CCTrCH, and mapping the CCTRCH to one physical channel (i.e., one code channel). Therefore, the E-DCH and the DCH are not independent of each other. Because an additional spreading code is not needed, the time multiplexing scheme causes no PAPR increase relative to the code multiplexing scheme.

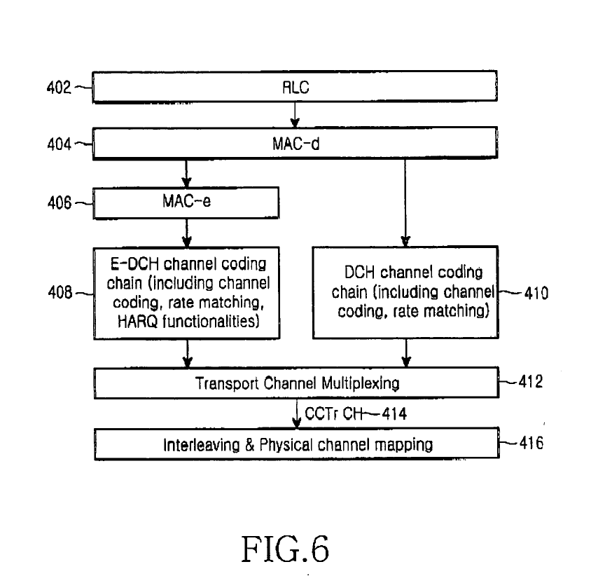

FIG. 6 illustrates a hierarchical architecture for time-multiplexing the E-DCH and the DCH. Referring to FIG. 6, a MAC-d layer 404 for processing the DCH generates a new data unit by attaching a predetermined header to data received from an overlying RLC layer 402 and transmits the new data unit to a PHY layer. The data from the MAC-d layer 404 is encoded separately according to transport channels in the PHY layer. A channel coding chain 410 in the PHY layer performs CRC attachment, channel encoding, interleaving, and rate matching on the data from the MAC-d layer 304.

While E-DCH data received from the RLC layer 302 through the MAC-d layer 404 can also be classified into a plurality of transport channels in a MAC-e layer 406, only one transport channel is illustrated for the E-DCH data herein. In the PHY layer, the E-DCH data is encoded in a channel coding chain 408. The channel coding chain 408 has the HARQ functionality in addition to the functionalities of the channel coding channel 410 of the DCH.

A transport channel MUX 412 time-multiplexes the coded DCH and E-DCH data to one data block. The data block is mapped to one CCTrCH 414. Accordingly, while one DCH and one E-DCH have been shown herein, if two or more DCHs and two or more E-DCHs are used, the transport channel MUX 412 multiplexes the DCHs and the E-DCHs to one CCTrCH. The multiplexed CCTrCH data is transmitted wirelessly on a code channel through an interleaver & physical channel mapper 416. According to the size of the CCTrCH data, one or more code channels can be used.

If a UE is in a good uplink channel status, a power gain required for an uplink channel to transmit the same amount of data is less than in a band uplink channel status. As the UE uses less transmit power, it can transmit more data without increasing a PAPR. However, if the UE is in a band uplink channel status, it increases its transmit power or decreases its data rate. Therefore, the PAPR is increased and a feature such as time diversity is needed.

Accordingly, a multiplexing scheme is selected for the E-DCH and DCH based on the uplink channel status of the UE in a preferred embodiment of the present invention. In a good uplink channel status, the code multiplexing scheme is selected to transmit/receive the E-DCH more efficiently without regard for the PAPR. The code multiplexing scheme enables the TTI (Transmission Time Interval) of the E-DCH to be shorter than that of the DCH, or enables use of a higher-order modulation scheme. Therefore, it is possible to efficiently the E-DCH at a high data rate. However, in a band uplink channel status, the time multiplexing scheme is used that does not increase the PAPR. A time diversity gain can be achieved by utilizing a relatively long TTI like the TTI of the DCH, thereby handling the band channel status.

As described above, the E-DCH is an enhanced version of the DCH that has been proposed for more efficient packet transmission. A significant part of establishing an uplink DCH is to share the TF of the DCH between a system and a UE. When establishing the DCH, an RNC determines available TFs for the DCH and transmits information about the TFs to the UE and the Node B. Therefore, channel establishment information common to the E-DCH and the DCH is determined by defining an appropriate transport block structure for the E-DCH in the preferred embodiment of the present invention.

A description will first be made of the establishment of the DCH.

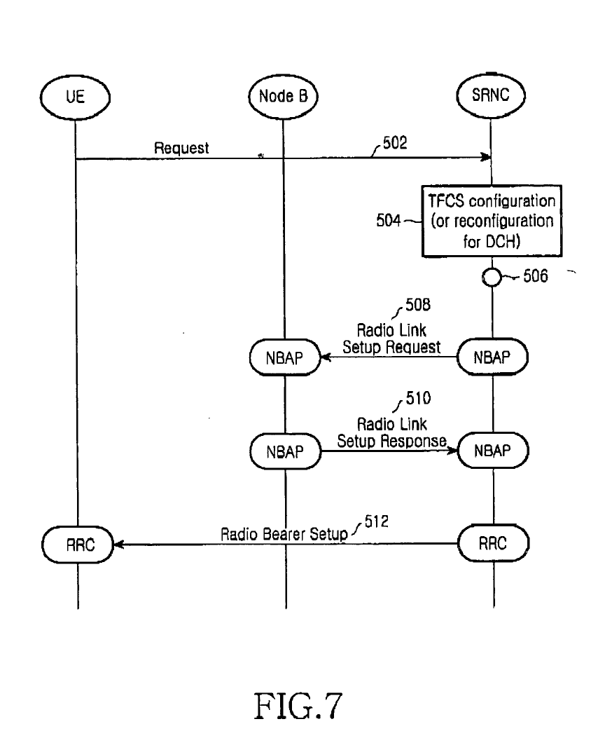

FIG. 7 is a diagram illustrating a signal flow for initially establishing the DCH. Referring to FIG. 7, when a UE requests establishment or reestablshiment of the DCH in step 502, an SRNC (Serving Radio Network Controller) establishes the DCH in step 504 and transmits DCH establishment information to a Node B by Node B Application Protocol (NBAP) signaling in step 508. In step 512, the RNC transmits the DCH establishment information to the UE by RRC signaling. NBPA is a signaling protocol for communications between a Node B and an RNC.

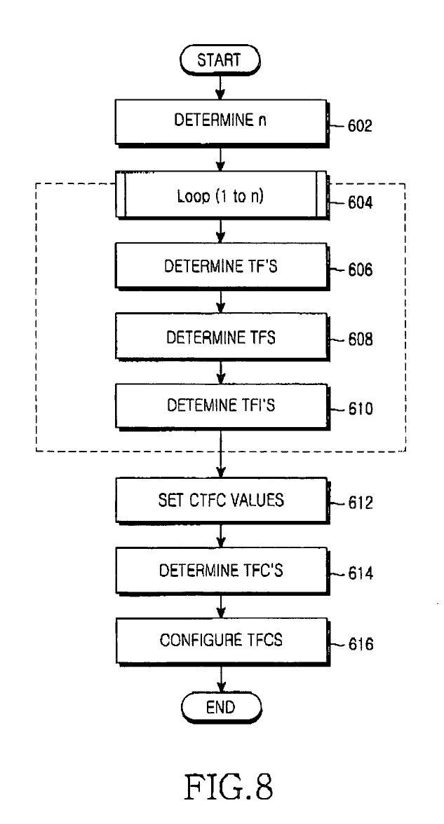

FIG. 8 is a detailed flowchart illustrating TF configuration of the uplink DCH in step 504. Referring to FIG. 8, the SRNC determines the number n of uplink DCHs to be used for the UE in step 602 and repeatedly runs a loop of determining the TFs of the respective DCHs in step 604. The loop is step 606 through step 610.

Regarding a k^{th} loop, available TFs are determined for a k^{th} DCH in step 606. At the same time, information destined for the UE and information destined for the Node B are set, which will be described later. In step 608, a TFS (Transport Format Set) including the available TFs is set. Each of the TFs is mapped to a TFI (Transport Format Indicator), thereby setting the TFIs for the k^{th} DCH.

After the TFs of the DCHs are completely set, all possible TF combinations of all the DCHs are represented as CTFCs (Calculated Transport Format Combinations). The representation of CTFC values is specified in 3 GPP TS 25.331 v5.5.0 clause 14.10 and thus its description will not be provided herein. The TF combinations of the DCHs are mapped to corresponding unique CTFC values, respectively.

In step 614, the SRNC chooses TFCs available to the UE among the CTFCs. The TFCs are set as a TFCS (Transport Format Combination Set) in step 1616. Thereafter, the SRNC returns to node 506 as illustrated in FIG. 7.

Referring to FIG. 7 again, after the configuration of the TFCS, the SRNC transmits the TFCS configuration information to the UE and the Node B. While this signaling can be performed in various ways by combining various pieces of information, a typical signaling is depicted in FIG. 7.

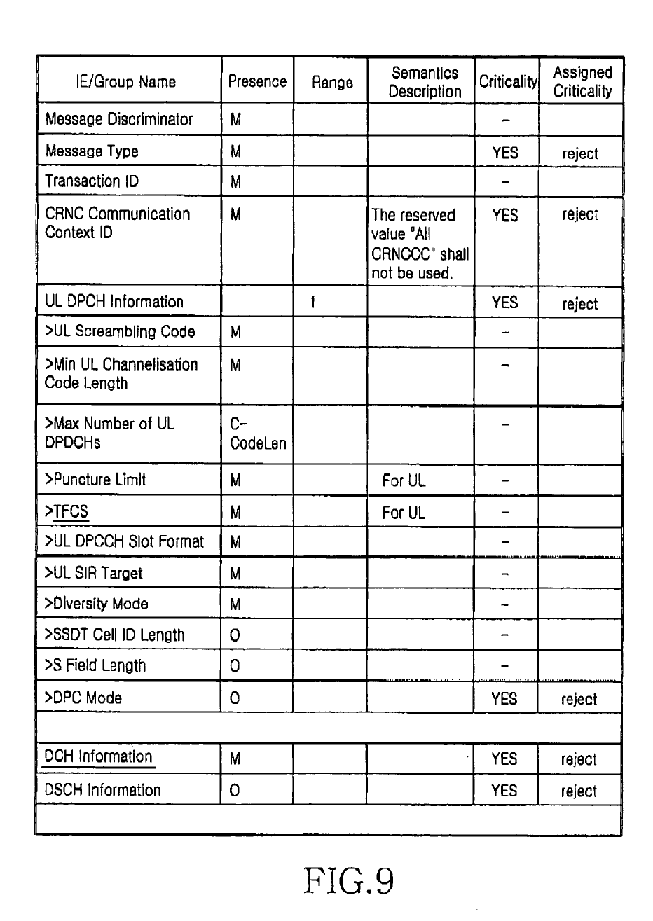

In step 508, the SRNC transmits to the Node B a Radio Link Setup Request message requesting the Node B to establish the DCHs. The format of the Radio Link Setup Request message is illustrated in FIG. 9. The Radio Link Setup Request message provides the Node B with the TFCs available to the UE.

Significant fields of the Radio Link Setup Request message, which are applied to the present invention, will be described with reference to FIG. 9. In FIG. 9, underlined TFCS and DCH Information fields provide the TFS-related information of the uplink DCHs. The TFCS field provides information about a DPCH (Dedicated Physical Channel) onto which the DCHs are mapped, and also includes CTFC information indicating TFCs available to the Node B. The DCH Information field provides DCH information. The DCH information includes the size and number of transport blocks.

If the Node B can accept the Radio Link Setup Request message, it transmits a Radio Link Setup Response message to the SRNC in step 510. Accordingly, the DCHs are established between the SRNC and the Node B.

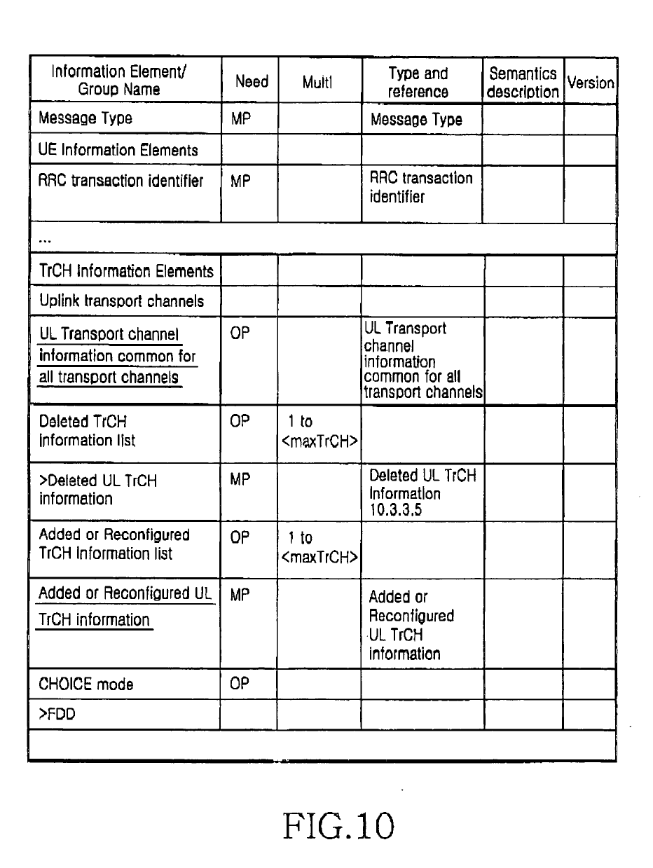

In step 512, the SRNC transmits the DCH establishment information to the UE by a Radio Bearer Setup message, the format of which is illustrated in FIG. 10. Regarding significant fields of the Radio Bearer Setup message, which are applied to the present invention, underlined fields provide the TFS-related information of the uplink DCHs. The UE acquires TFCS information indicating possible TFSs by the Radio Bearer Setup message.

In FIG. 10, UL Transport Channel Information field is common for all transport channels. It includes the TFCS of the uplink DCHs. The TFCS indicates TFCs enabled to the UE by CTFC values. Added or Reconfigured UL TrCH Information includes TFS information for each DCH. The TFS information includes an RLC size indicating a data size of the RLC layer, and a number of transport blocks. The sum of the RLC size and the size of a MAC header is the size of a transport block.

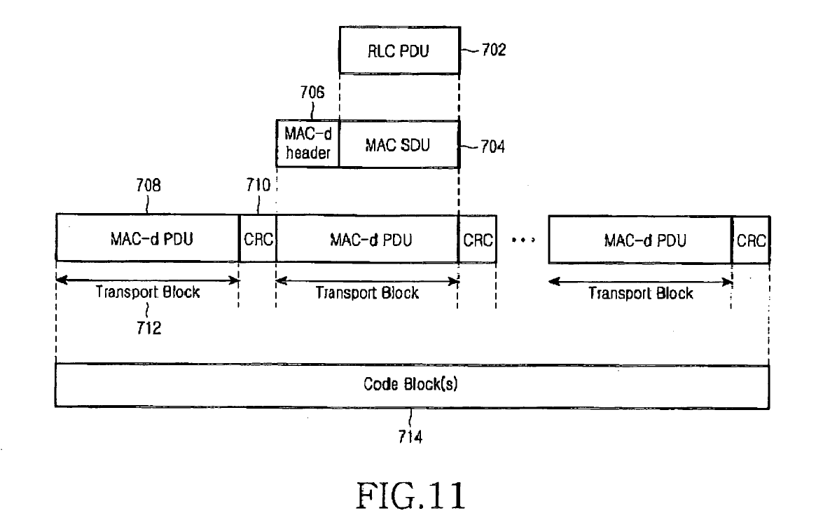

FIG. 11 illustrates transport blocks, RLC size, the number of the transport blocks, and a transport block set that are used to configure a DCH. Referring to FIG. 11, reference numeral 702 denotes an RLC PDU (Packet Data Unit) transferred from the RLC layer to the MAC layer. The size of the RLC PDU is known from the RLC size included in the RRC message of step 512. The RLC PDU is a MAC SDU (Service Data Unit) 704 in the MAC-d layer. A MAC-d PDU is created by attaching a MAC-d header 706 to the MAC SDU 704. For the DCH, the MAC-d PDU 708 is called a transport block in the PHY layer. The PHY layer attaches a CRC 710 to each MAC-D PDU 706. The size of the CRC 710 is determined for each TF and notified to the Nod B and the UE by the SRNC.

The number of transport blocks commonly included in the Radio Link Setup Request message and the Radio Bearer Setup message indicates an encoded unit of a transport channel in the PHY layer. That is, the PHY layer encodes as many CRC-attached transport blocks as the transport block number at one time.

Referring to FIG. 11, a plurality of transport blocks 712 and CRCs 710 collectively form one data unit. Because the data unit is an input unit of an encoder in the PHY layer, it is called a code block 714. While the code block 174 may be segmented to a predetermined size according to an encoder input rule, it is beyond the scope of the present invention and will not be described in detail herein.

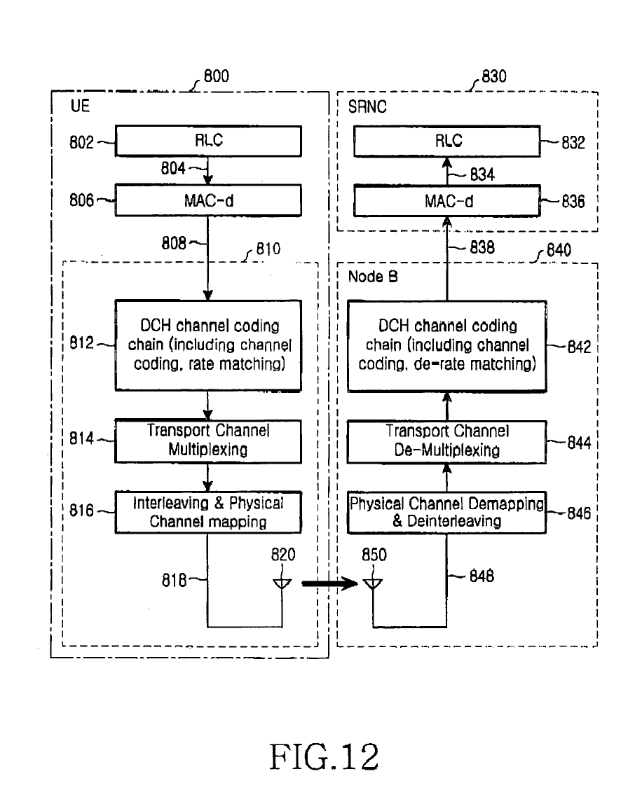

FIG. 12 illustrates a hierarchical structure for transmitting data units on an uplink DCH from the UE to the Node B. Referring to FIG. 12, reference numeral 800 denotes a UE, reference numeral 830 denotes an SRNC, and reference numeral 840 denotes a Node B. The UE 800 has knowledge of an available TFCS and stores available TFCs as CTFC values. The TFCs each indicate an RLC size and the number of transport blocks for a TF. When the UE 800 chooses a TFC from the TFCS, it determines RLC sizes corresponding to the TFs of DCHs set in the TFC. A data flow for one DCH will be described by way of example herein below.

An RLC layer 802 generates an RLC PDU 804 of a predetermined RLC size and a MAC-d layer 806 generates a MAC-d PDU 808 by attaching a MAC-d header to the RLC PDU 804. The MAC-d layer 806 generates as many MAC-d PDUs 808 as the number transport blocks set in the TF of the DCH, and simultaneously transmits them to a PHY layer 810.

The PHY layer 810 generates transport blocks by attaching CRCs to the MAC-d PDUs 808 and encodes them through an encoding chain 812. When a plurality of DCHs are used, a transport channel MUX 814 time-multiplexes code blocks of the DCHs. The multiplexed CCTrCH data is mapped to a corresponding physical channel, that is, a DPDCH through an interleaver & physical channel mapper 816.

Because the TF of the physical channel is changed at every TTI, TFC information about the transport blocks must be transmitted to the Node B. Therefore, the PHY layer 810 sets TFCIs corresponding to the TFCs that the UE knows and transmits to the Node B a TFCI indicating the TFC of the transport blocks on a control channel related to the DCH, DPCCH through an antenna 820.

The PHY layer of the Node B 840 searches the TFCS information received from the RNC 830 for the TFC of a physical channel frame 848 received through an antenna 850 using the TFCI received from the UE 800. The physical channel frame 848 is processed according to the TFC in a physical channel demapper & deinterleaver 846, a demultiplexer (DEMUX) 844, and a channel coding chain 842.

The output 838 of the PHY layer involves a plurality of MAC-D PDUs. Because the Node B 840 already knows the number of the MAC-d PDUs, a MAC-d layer 836 extracts RLC PDUs 834 by interpreting the MAC-d headers of the MAC-d PDUs and transmits them to an RLC layer 832.

As described above, the SRNC configures the TFCS of uplink DCHs, transmits TFCS-related information about TFSs, CTFC values, and the size and number of transport blocks to the Node B, and transmits information about the TFSs, the CTFC values, an RLC size, and the number of transport blocks, thereby enabling uplink transmission of the DCHs.

In accordance with an preferred embodiment of the present invention, when the UE requests establishment of the E-DCH or DCH, or establishment of multiplexed E-DCH and DCH, TFS-related information common to the E-DCH and the DCH is provided to the UE and the Node B. Specifically, when time multiplexing the E-DCH and the DCH, the common TFS-related information is essential.

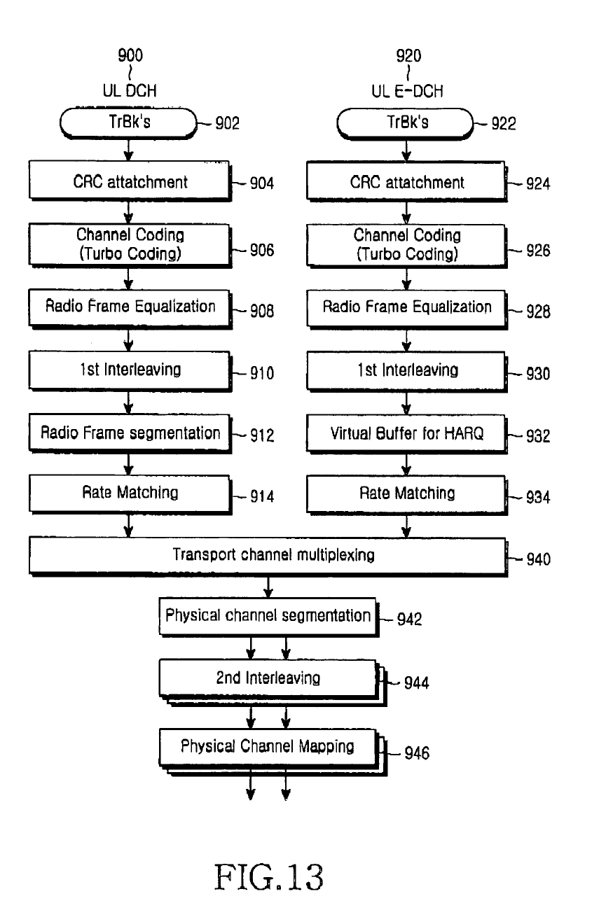

FIG. 13 is a flowchart illustrating an operation for time-multiplexing the E-DCH and the DCH in the PHY layer according to the present invention. In FIG. 13, one DCH and one E-DCH are time-multiplexed to one CCTRCH. Reference numeral 900 denotes steps for the DCH, and reference numeral 920 denotes steps for the E-DCH.

Referring to FIG. 13, the MAC-d layer transfers uplink (UL) DCH data in the form of transport blocks (TrBKs) to the PHY layer in step 902. The respective transport blocks are attached with CRCs in step 904 and channel-encoded in step 906. The coded data is subject to radio frame equalization to match the number of radio frames in step 908 and interleaved in step 910. The interleaved data is segmented into the radio frames in step 912 and rate-matched to an appropriate number of bits in step 914. Step 912 is performed when a TTI is longer than one radio frame, e.g., 10 ms.

The MAC-e layer transfers E-DCH data in the form of transport blocks to the PHY layer in step 922. The respective transport blocks are attached with CRCs in step 924 and channel-encoded in step 926. Preferably, the channel coding is performed by turbo coding. The coded data is subject to radio frame equalization to match the number of radio frames in step 928 and interleaved in step 930. The interleaved data is stored in a virtual buffer to support HARQ of the E-DCH in step 932 and rate-matched to an appropriate number of bits according to the HARQ in step 934.

In step 940, the rate-matched DCH data and the rate-matched E-DCH data are time-multiplexed in terms of transport channels. The multiplexed information bits are distributed to a plurality of physical channels according to the data rate of the physical channels in step 942. That is, if the data rate of the multiplexed bits is too high to be transmitted on one physical channel, at least two physical channels are used. The distributed information bits are interleaved on a radio frame basis for each physical channel in step 944 and mapped to the corresponding physical channels in step 946.

For the DCH, MAC-d PDUs produced by attaching MAC-d headers to RLC PDUs are used as transport blocks, the TFCS of the DCH is set according to the size of the transport blocks, and the TFCS information is transmitted to the Node B and the UE.

To indicate the TF of E-DCH data by physical channel information, a TFCI, as is done for the DCH, the structure and size of E-DCH transport blocks are determined to set the same TFCS for the E-DCH and the DCH in the embodiment of the present invention. Using the same TFCS means that a PHY layer operation for the E-DCH is at least partially identical to that for the DCH.

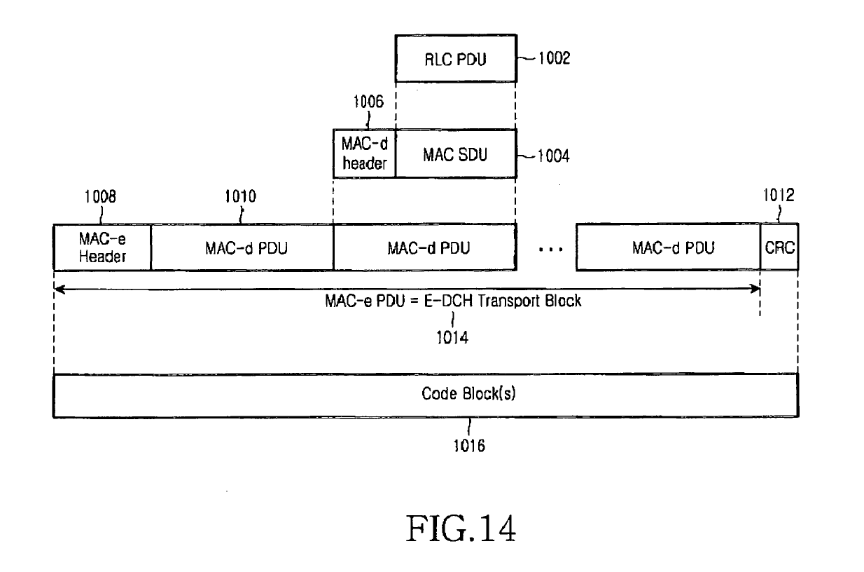

FIG. 14 illustrates the relationship between data blocks in protocol layers according to an embodiment of the present invention. Referring to FIG. 14, reference numeral 1002 denotes an RLC PDU for the E-DCH. The RLC PDU 1002 is equivalent to a MAC SDU 1004 in the MAC-d layer. The MAC-d layer generates a MAC-d PDU 1010 by attaching a MAC-d header 1006 to the MAC SDU 1004.

The MAC-e layer forms a MAC-e SDU by concatenating a plurality of MAC-d PDUs 1010 and generates a MAC-e PDU 1014 by attaching a MAC-e header 1008 to the MAC-e SDU. A code block is 1016 created by attaching a CRC 1012 to the MAC-e PDU 1014. The code block 1016 is then mapped to a physical channel as described with reference to FIG. 13, in the PHY layer. The size of a transport block in the PHY layer is that of the MAC-e PDU 1014.

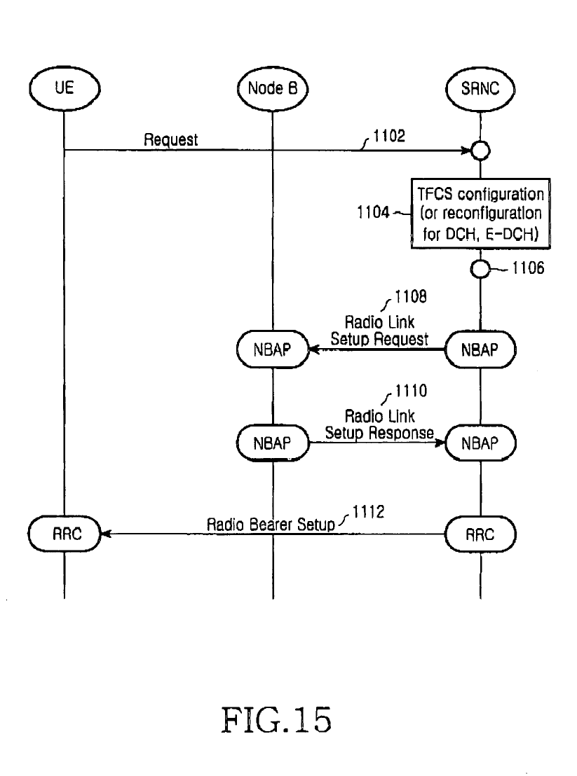

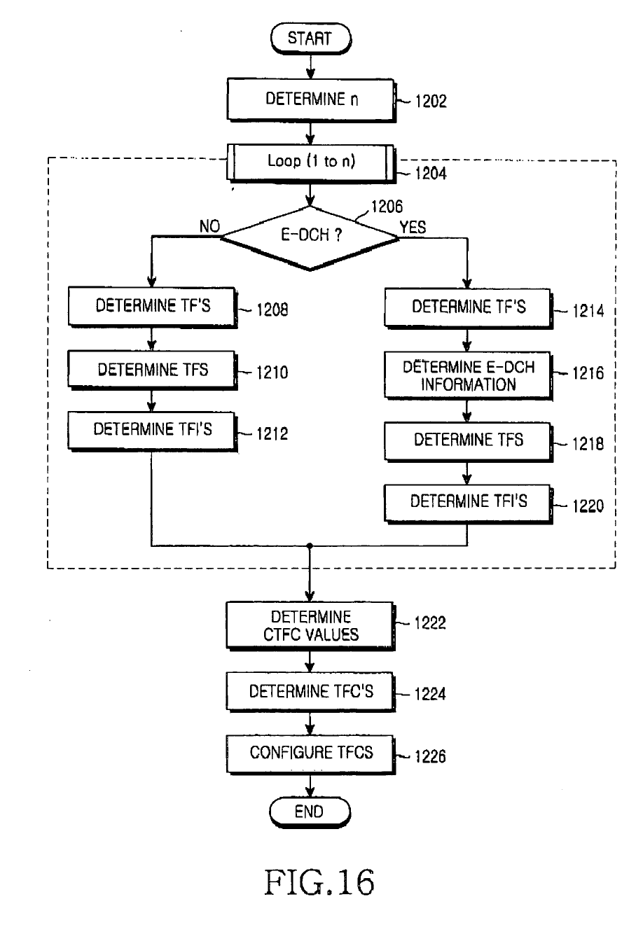

FIG. 15 is a diagram illustrating a signal flow for establishing the E-DCH and the DCH according to an embodiment of the present invention and FIG. 16 is a flowchart illustrating an operation for configuring the TFCS of the DCH and the E-DCH in the SRNC according to an embodiment of the present invention. More specifically, FIG. 16 depicts step 1104 of FIG. 15 in more detail.

Referring to FIG. 15, when the UE requests establishment of at least one DCH and/or at least one E-DCH in step 1102, the SRNC configures or reconfigures the TFCS of the E-DCH and/or DCH and generates setup information of the E-DCH and/or DCH in step 1104. The SRNC transmits the setup information to the Node B by NBAP signaling in step 1108. The setup information includes TFS-related information common to the DCH and the E-DCH. The Node B configures the PHY layer according to the setup information to receive the E-DCH and/or DCH. In step 1112, the SRNC transmits the setup information to the UE by RRC signaling. Similarly, the UE configures the PHY layer according to the setup information to transmit the E-DCH and/or DCH.

Referring to FIG. 16, step 1104 will be described in more detail. The SRNC determines the total number n of E-DCHs and/or DCHs to be established in step 1202 and repeats a loop of setting the TFS of each of the n channels in step 1204. The loop is run in steps 1206 through 1220.

Regarding a k^{th} loop, the SRNC determines whether a k^{th} channel is an E-DCH in step 1206. If the k^{th} channel is not an E-DCH, the SRNC determines TFs available to the k^{th} channel (i.e., a DCH) and sets a TFS and TFIs for the k^{th} channel in the same manner as illustrated in FIG. 8 in steps 1208, 1210, and 1212. If the k^{th} channel is an E-DCH, the SRNC determines TFs available to the E-DCH in step 1214, determines the E-DCH information in step 1216, and sets TFS information for each of the TFs considering the characteristic of the E-DCH in step 1218. That is, the size of an E-DCH transport block is the sum of the total length of as many MAC-d PDUs attached with MAC-e headers as the number of DCH transport blocks. The number of E-DCH transport blocks is 1 all the time. That is, the SRNC calculates the size and number of E-DCH transport blocks by Equation (1),
TB(E-DCH)=TB_num(DCH)×TB(DCH) TB_num(E-DCH)=I
where TB(E-DCH) is the size of an E-DCH transport block, TB_num(DCH) is the number of DCH transport blocks, and TB(DCH) is the size of the DCH transport blocks. TB_num(E-DCH) is always 1. Because the size of a MAC-e header is preset between the Node B and the UE, the SRNC does not need notify the MAC-e header size. Therefore, the MAC-e header size is ignored. In practice, the size of an E-DCH transport block is the sum of a transport block size notified by the SRN and the MAC-e header size.

Once the size and number of E-DCH transport blocks are determined, the SRNC sets a TFS by combining the determined TFs in step 1218 and sets TFIs for the k^{th} channel by mapping the TFs to respective TFIs in step 1220.

In step 1222, all possible combinations of the TFs of all the channels including the E-DCH and the DCH are mapped to corresponding CTFC values. The SRNC determines TFCs available to the UE in step 1224, sets the determined TFCs as a TFCS for the UE in step 1226, and returns node 1106 as illustrated in FIG. 15.

After the TFCS is completely configured in the procedure illustrated in FIG. 16, the SRNC transmits the TFS-related information of the channels including the E-DCH and the DCH to the Node B by a Radio Link Setup Request message in step 1108 in FIG. 15 and receives a Radio Link Setup Response message from the Node B in step 1110. In step 1112, the SRNC transmits to the UE a Radio Bearer Setup message including the E-DCH and DCH setup information. The UE acquires the TFCS being a set of the available TFSs by the Radio Bearer Setup message.

The TFS-related information provided to the Node B and the UE is determined depending on the position of the MAC-e layer. If both the MAC-d layer and the MAC-e layer are in the SRNC, the SRNC sets the size and number of transport blocks in the E-DCH TFS-related information to be transmitted to the Node B, as illustrated in FIG. 7. The size and number of transport blocks are determined for the E-DCH as shown in Equation (1). The Node B decodes E-DCH or DCH data received from the UE using the transport block size and number without differentiating the E-DCH from the DCH. The MAC-e layer is responsible for differentiating the E-DCH from the DCH. E-DCH TFS-related information that the SRNC transmits to the UE contains an RLC size, the number of transport blocks, and the number of MAC-d PDUs per MAC-e PDU. Here, the number of transport blocks is 1. The UE acquires MAC-e PDUs using the TFS-related information through the MAC-e layer. If the size of a MAC-e header is not constant, the SRNC includes header size information in the TFS-related information. The number of MAC-d PDUs per MAC-e PDU may eventually be equal to that of DCH transport blocks.

When the MAC-e layer is in the Node B and the MAC-d layer is in the SRNC, the E-DCH TFS-related information that the SRNC transmits to the Node B includes the size of a MAC-d PDU and the number of MAC-d PDUs per MAC-e PDU. The MAC-e layer of the Node B determines parameters for a MAC-e PDU and the PHY layer using the TFS-related information and decodes E-DCH data received from the UE based on the parameters. If the size of a MAC-e header is not constant, the SRNC includes header size information in the TFS-related information. The SRNC transmits to the UE the same E-DCH TFS-related information as in the case where the MAC-e layer is in the SRNC.

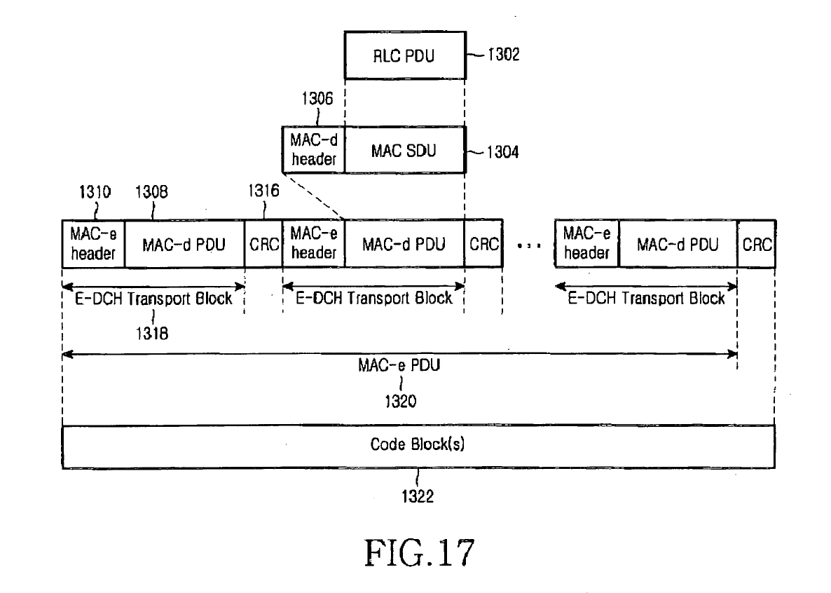

FIG. 17 illustrates a relationship between data blocks in protocol layers according to a second embodiment of the present invention. Referring to FIG. 17, reference numeral 1302 denotes an RLC PDU for the E-DCH. The RLC PDU 1302 is equivalent to a MAC SDU 1304 in the MAC-d layer. The MAC-d layer generates a MAC-d PDU 1308 by attaching a MAC-d header 1310 to the MAC SDU 1304.

The MAC-e layer forms a MAC-e PDU 1320 by attaching a MAC-e header 1310 to each MAC-d PDU 1308 and concatenating a plurality of MAC-d PDUs 1308 having MAC-e headers 1310 attached thereto. A pair of a MAC-d PDU 1308 and a MAC-e header 1310 is defined as an E-DCH transport block 1318. The MAC-e PDU 1320 is provided to the PHY layer.

The PHY layer creates a code block 1322 by attaching a CRC 1316 to the end of each E-DCH transport block 1318 included in the MAC-e PDU 1320 and maps the code block 1322 to a physical channel as described with reference to FIG. 13. The size of a transport block in the PHY layer is the sum of the sizes of a MAC-d PDU and a MAC-e header.

In accordance with the second embodiment of the present invention, a MAC-e PDU includes a plurality of MAC-e headers. The same information is set in the MAC-e headers or one of as many segments of the information as the number of transport blocks is set in each MAC-e header. More specifically, in the former case, the MAC-e layer generates as many copies of MAC-e header information as the number of transport blocks and inserts a copy before each MAC-d PDU 1308. In the latter case, the MAC-e layer segments the MAC-e header information by the number of the transport blocks and inserts a segment before each MAC-d PDU 1208.

A signaling procedure for establishing the E-DCH according to the second embodiment of the present invention will be described herein below with reference to FIG. 16.

Referring to FIG. 16, the SRNC determines the total number n of E-DCHs and DCHs to be established in step 1202 and repeats a loop of setting a TFS and TFIs for each of the n channels in step 1204. The loop is run in steps 1206 through 1220.

In each loop, the SRNC determines whether an input channel is an E-DCH in step 1206. If the input channel is an E-DCH, the SRNC determines TFs available to the E-DCH in step 1214 and determines TFS information for each of the TFs in step 1218. The size of an E-DCH transport block is the sum of the length of a DCH transport block and the length of a MAC-e header, that is, the sum of the lengths of a MAC-d PDU and a MAC-e header. The number of E-DCH transport blocks is equal to that of DCH transport blocks. That is, the SRNC calculates the size and number of E-DCH transport blocks by Equation (2).
TB(E-DCH)=TB(DCH)+MAC-e Header_Size TB_num(E-DCH)=TB_num(DCH) (2)

Once the size and number of E-DCH transport blocks are determined in step 1216, the SRNC sets a TFS and TFIs for the E-DCH in steps 1218 and 1220 and signals the TFS-related information to the Node B and the UE.

If both the MAC-d layer and the MAC-e layer are in the SRNC, the SRNC sets the size and number of transport blocks in the E-DCH TFS-related information to be transmitted to the Node B. The size and number of transport blocks are determined for the E-DCH by Equation (2). The Node B decodes E-DCH data received from the UE using the transport block size and number without differentiating the E-DCH from the DCH. The MAC-e layer is responsible for differentiating the E-DCH from the DCH.

E-DCH TFS-related information that the SRNC transmits to the UE includes an RLC size and the number of transport blocks, like DCH TFS-related information. The UE forms one MAC-e PDU out of a plurality of MAC-d PDUs according to the number of transport blocks and transmits the MAC-e PDU to the PHY layer. If the size of a MAC-e header is not constant, the SRNC includes header size information in the TFS-related information.

When the MAC-e layer is in the Node B and the MAC-d layer is in the SRNC, the E-DCH TFS-related information that the SRNC transmits to the Node B includes the size of a MAC-d PDU and the number of MAC-d PDUs per MAC-e PDU. The MAC-e layer of the Node B determines parameters for a MAC-e PDU and the PHY layer using the TFS-related information and decodes E-DCH data received from the UE based on the parameters. If the size of a MAC-e header is not constant, the SRNC includes header size information in the TFS-related information. The SRNC transmits to the UE the same E-DCH TFS-related information as in the case where the MAC-e layer is in the SRNC.

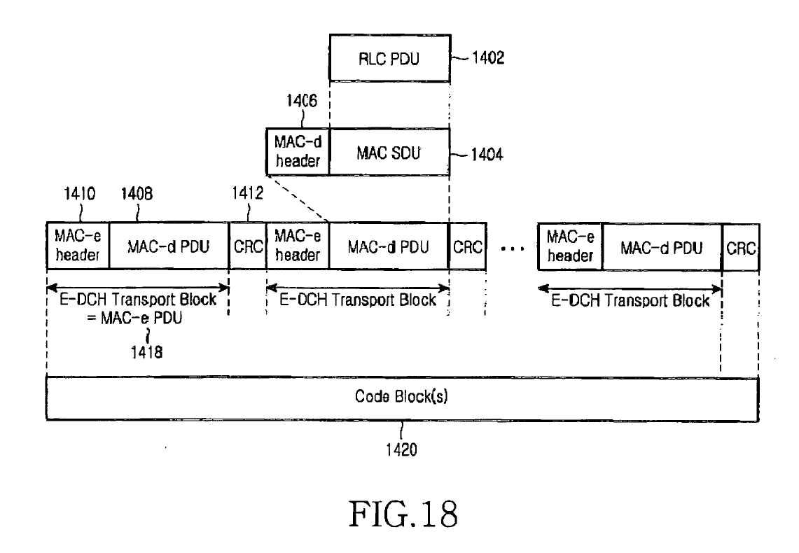

FIG. 18 illustrates the relationship between data blocks in protocol layers according to a third embodiment of the present invention. Referring to FIG. 18, reference numeral 1402 denotes an RLC PDU for the E-DCH. The RLC PDU 1402 is equivalent to a MAC SDU 1404 in the MAC-d layer. The MAC-d layer generates a MAC-d PDU 1408 by attaching a MAC-d header 1406 to the MAC SDU 1404. The MAC_d PDU 1408 is equivalent to a MAC-e SDU in the MAC-e layer. The MAC-e layer forms a MAC-e PDU 1418 by attaching a MAC-e header 1410 to each MAC-d PDU 1408. The MAC-e PDU 1418 is defined as an E-DCH transport block.

As many MAC-e PDUs 1418 as the number of transport blocks are provided to the PHY layer. The PHY layer creates a code block 1420 by attaching a CRC 1412 to the end of each transport block 1418 and maps the code block 1420 to a physical channel as described with reference to FIG. 13. The size of a transport block in the PHY layer is the size of the MAC-e PDU 1418 including the MAC-d PDU 1408 and the MAC-e header 1410.

In accordance with the third embodiment of the present invention, a different data block structure is utilized but the same TFS-related information is transmitted, when compared to the second embodiment. However, because the MAC-e PDU is defined differently, the information of the MAC-e header is also different.

A signaling procedure for establishing the E-DCH according to the third embodiment of the present invention will be described with reference to FIG. 16.

Referring to FIG. 16, the SRNC determines the total number n of E-DCHs and DCHs to be established in step 1202 and repeats a loop of setting a TFS and TFIs for each of the n channels in step 1204. The loop is run in steps 1206 through 1220.

In each loop, the SRNC determines whether an input channel is an E-DCH in step 1206. If the input channel is an E-DCH, the SRNC determines TFs available to the E-DCH in step 1214. The size of an E-DCH transport block is the sum of the length of a DCH transport block and the length of a MAC-e header, that is, the sum of the lengths of a MAC-d PDU and a MAC-e header. The number of E-DCH transport blocks is equal to that of DCH transport blocks. That is, the SRNC calculates the size and number of E-DCH transport blocks by Equation (3).
TB(E-DCH)=TB(DCH)+MAC-e Header_Size TB_num(E-DCH)=TB_num(DCH) (3)

Once the size and number of E-DCH transport blocks are determined in step 1216, the SRNC sets a TFS and TFIs for the E-DCH in steps 1218 and 1220 and signals the TFS-related information to the Node B and the UE.

If both the MAC-d layer and the MAC-e layer are in the SRNC, the SRNC sets the size and number of transport blocks in the E-DCH TFS-related information to be transmitted to the Node B. The size and number of transport blocks are determined for the E-DCH by Equation (3). The Node B decodes E-DCH data received from the UE using the transport block size and number without differentiating the E-DCH from the DCH. The MAC-e layer is responsible for differentiating the E-DCH from the DCH.

E-DCH TFS-related information that the SRNC transmits to the UE contains an RLC size and the number of transport blocks, like DCH TFS-related information. If the size of a MAC-e header is not constant, the SRNC includes header size information in the TFS-related information.

When the MAC-e layer is in the Node B and the MAC-d layer is in the SRNC, the E-DCH TFS-related information that the SRNC transmits to the Node B includes the size of a MAC-d PDU and the number of MAC-d PDUs per MAC-e PDU. The MAC-e layer of the Node B determines parameters for a MAC-e PDU and the PHY layer using the TFS-related information, and decodes E-DCH data received from the UE based on the parameters. If the size of a MAC-e header is not constant, the SRNC includes header size information in the TFS-related information. The SRNC transmits to the UE the same E-DCH TFS-related information as in the case where the MAC-e layer is in the SRNC.

Configuration of common TFS-related information for the E-DCH and the DCH has been described above. The use of the common TFS-related information enables time-multiplexing of the E-DCH and the DCH. As described above, the time multiplexing is preferable to the code multiplexing in a bad uplink channel status.

Typically, when a UE is located at the boundary of the service area of a Node B, it is placed in a bad uplink channel status. At the boundary of the Node B, the UE may be connected to two or more Node Bs via channels by a soft handover (SHO). In this case, the UE is said to be in an SHO region.

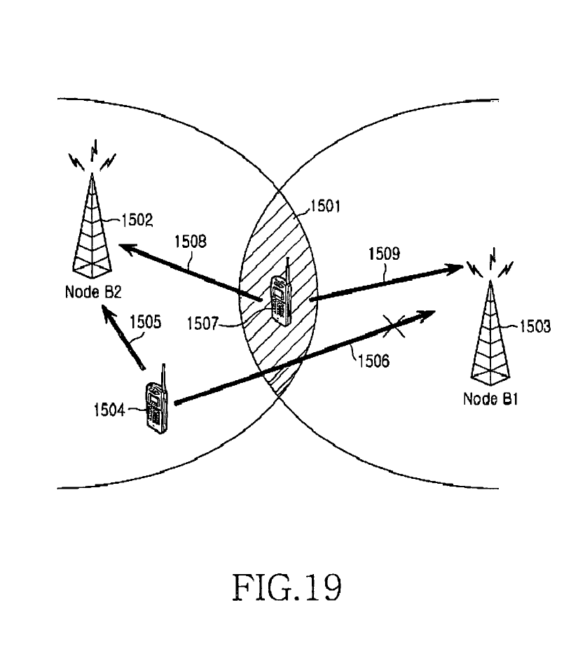

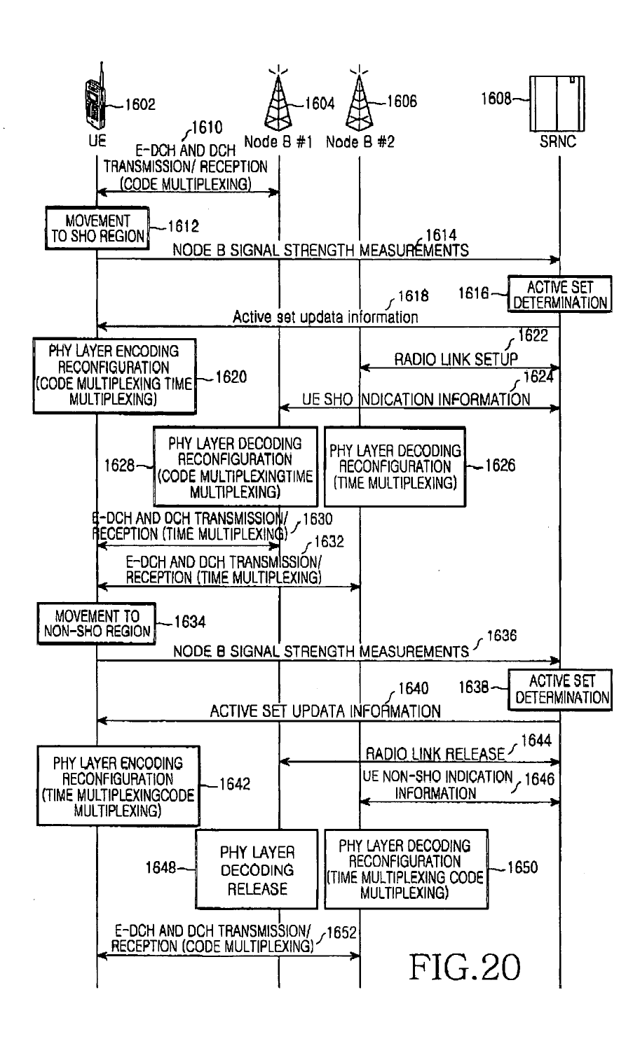

FIG. 19 illustrates the movement of a UE in an SHO region. Referring to FIG. 19, if Node Bs 1502 and 1503 (Node B2 and Node B1, respectively) are neighboring each other, a signal from a UE 1507 in a predetermined region 1501 reaches the two Node Bs 1502 and 1503 with sufficient power. This region 1510 is called an SHO region.

To describe the SHO situation in more detail, a signal 1505 from a UE 1504 reaches the Node B 1502 and a signal 1506 from the Node B 1504 does not reach the Node B 1503. The UE 1504 is said to be located in a non-SHO region. Therefore, only the Node B 1502 is included in an active set for the UE 1504 and the UE 1504 communicates only with the Node B 1502. However, signals 1508 and 1509 from the UE 1507 reach the Node Bs 1502 and 1503, respectively. Then, the UE 1507 is said to be in an SHO region. Both the Node Bs 1502 and 1503 are included in an active set for the UE 1507 and thus the UE 1507 communicates with the Node Bs 1502 and 1503.

Because the SHO region is generally the boundary between associated Node Bs, the UE in the SHO region is placed in a band uplink channel status and increases its transmit power. Therefore, when the UE enters the SHO region, the system considers that the UE is in a bad uplink channel status. If the UE moves out of the SHO region, the system considers, to the contrary, that the UE is in a good uplink channel status. Whether the UE is in the SHO region or not is determined by the number of Node Bs, that is, cells included in the active set of the UE. If one cell is in the active set, the uplink channel status is good, and if more cells are in the active set, it is bad. Both the UE and an SRNC for controlling the radio resources of the UE manage the active set. The SRNC determines the active set of the UE and the UE determines if it is in the SHO region by the active set information received from the SRNC.

FIG. 20 is a diagram illustrating a signal flow for a selective multiplexing operation in the UE, Node B, and RNC according to a preferred embodiment of the present invention. FIG. 20 illustrates a UE 1602 for transmitting uplink packet data, first and second Node Bs 1604 and 1606 (Node B #1 and Node B #2), which are adjacent to the UE 1602, and an SRNC 1608 for controlling communications of the UE.

Referring to FIG. 20, the UE 1602 establishes at least one E-DCH and at least one DCH with Node B #1 1604 and transmits data on the E-DCH and the DCH to Node B #1 1604 in a non-SHO state in step 1610. The active set of the UE 1602 includes Node B #1 1604 only. That is, in the non-SHO state, the UE 1602 code-multiplexes the E-DCH and the DCH and transmits them. Node B #1 1604 receives the E-DCH and DCH through code-demultiplexing.

As the UE 1602 approaches Node B #2 1606 and enters an SHO region in step 1612, it reports the received signal strengths of Node B #1 and Node B #2 1606 to the SRNC 1608 in step 1614. The SRNC 1608 determines the active set of the UE 1602 based on the reported signal strengths in step 1616. If the SRNC 1608 determines to include Node B #1 1604 and Node B #2 1606 in the active set, it transmits active set update information to the UE 1602 in step 1618. In step 1622, the SRNC 1608 transmits radio link setup information to Node B #2 1606, such that Node B #2 1606 can receive the E-DCH from the UE 1602. The radio link setup information includes information indicating the presence of the UE 1603 in the SHO region and TFS information for the E-DCH and the DCH. The SRNC 1608 transmits SHO indication information to Node B #1 1604, notifying the movement of the UE 1602 to the SHO region in step 1624.

By the above signaling, the UE 1602, Node B #1 1604, and Node B #2 1606 know that the UE 1602 has entered the SHO region, and the transport channel multiplexing scheme is changed from the code multiplexing to time multiplexing. More specifically, in step 1620, the UE 1602 finds out that it has moved to the SHO region by the active set update information and configures a PHY layer time-multiplexing structure for time-multiplexing the E-DCH and the DCH through reconfiguration of PHY layer encoding. That is, the UE 1602 reconfigures the E-DCH and DCH multiplexing structure illustrated in FIG. 5 to that illustrated in FIG. 6. In step 1628, Node B #1 1604 reconfigures a protocol layer structure for E-DCH and DCH demultiplexing as a time-demultiplexing structure through reconfiguration of PHY layer decoding. Node B #2 1606 also reconfigures a protocol layer structure for E-DCH and DCH demultiplexing as a time-demultiplexing structure through configuration of PHY layer decoding in step 1626. In steps 1630 and 1632, the UE 1602 transmits E-DCH data and DCH data to Node B #1 1604 and Node B #2 1606 in time multiplexing.

As the UE 1602 further moves to Node B #2 1606 and enters a non-SHO region in step 1634, it signals signal strength measurements of Node B #1 1604 and Node B #2 1606 to the SRNC 1608 in step 1636. The SRNC 1608 determines again the active set of the UE 1602 based on the signal strength measurements in step 1638. The SRNC 1608 deletes Node B #1 1604 from the active set and chooses to remain Node B #2 1606 in the active set. In step 1640, the SRNC 1608 notifies the UE 1602 of the determination result by active set update information. The UE 1602 recovers the protocol structure for E-DCH and DCH multiplexing to the code multiplexing structure in response for the active set update information in step 1642.

In step 1644, the SRNC 1608 transmits a Radio Link Release message to Node B #1 1604 to terminate communication between Node B #1 1604 and the UE 1602. Node B #1 1604 terminates reception and decoding of the E-DCH and the DCH from the UE 1602 in step 1648. The SRNC 1608 transmits non-SHO indication information to Node B #2 1606, notifying the presence of the UE 1602 in the non-SHO region in step 1646. Therefore, Node B #2 1606 recovers the demultiplexing structure for receiving the E-DCH and DCH from the UE to the code demultiplexing structure in step 1650. Accordingly, the UE 1602 transmits data on the code-multiplexed E-DCH and DCH to Node B #2 1606 in step 1652.

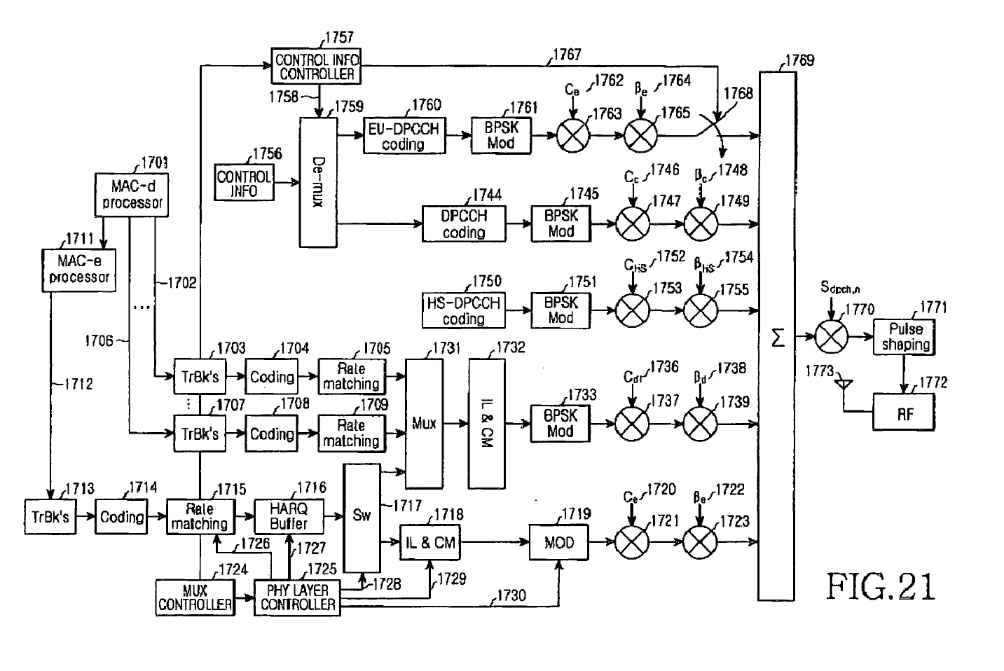

FIG. 21 is a block diagram of a transmitter for selective multiplexing in the UE according to the preferred embodiment of the present invention. The transmitter selects either code multiplexing or time multiplexing in order to multiplex the E-DCH and the DCH.

Referring to FIG. 21, MAC-d PDUs 1702 to 1706 for the DCH generated from a MAC-d processor 1701 are output according to transport channels. Transport block generators 1703 to 1707 each generate a DCH transport block by combining a predetermined number of DCH MAC-d PDUs 1702 to 1706. The DCH transport blocks are input to a MUX 1731 through channel encoders 1704 to 1708 and rate matchers 1705 to 1709.

A MAC-e processor 1711 generates MAC-e PDUs 1712 for the E-DCH by attaching MAC-e headers to MAC-d PDUs for the E-DCH generated from the MAC-d processor 1701. A transport block generator 1713 generates E-DCH transport blocks by combining E-DCH MAC-e PDUs 1712. The E-DCH transport blocks are stored in a HARQ buffer 1716 through a channel encoder 1714 and a rate matcher 1715.

A multiplexing controller 1724 selects a multiplexing scheme for the E_DCH and the DCH, and notifies a PHY layer controller 1725 of the selected multiplexing scheme. For example, the multiplexing controller 1724 determines whether an SHO has occurred by the number of cells in the active set of the UE set in active set update information received from the SRNC. If the UE is in an SHO situation, the multiplexing controller 1724 selects the time multiplexing. If the UE is in a non-SHO situation, the multiplexing controller 1724 selects the code multiplexing. When the E-DCH and the DCH are not multiplexed, the multiplexing controller 1724 selects the code multiplexing.

The PHY layer controller 1725 controls the rate matcher 1715 and the HARQ buffer 1716 by respective control signals 1726 and 1727, thereby enabling the E-DCH data to be appropriately processed according to the selected multiplexing scheme. More specifically, the PHY layer controller 1725 determines whether to map the E-DCH data stored in the HARQ buffer 1716 to a CCTRCH separately from the DCH data (code multiplexing) or to map the E-DCH data and the DCH data together to a CCTrCH (time multiplexing).

When code multiplexing, the PHY layer controller 1725 controls a switch 1717 by a control signal 1728 to switch the buffered E-DCH data to an interleaver & channel mapper (IL & CM) 1718. The switch 1717 connects the E-DCH data read from the HARQ buffer 1716 to the IL & CM 1718 according to the control signal 1728. The IL & CM 1718 interleaves the E-DCH data and maps the interleaved E-DCH data to a corresponding physical channel, e.g., EU-DPDCH. The mapped physical channel frame is modulated in a modulation scheme by a modulator 1719, spread with a spreading code Cₑ 1720 by a spreader 1721, multiplied by a channel gain 1722 by a channel gain adjuster 1723, and input to a channel summer 1769. That is, by code multiplexing, the E-DCH data is transmitted using a different CCTrCH and a different code channel from those of the DCH data. The PHY layer controller 1725 applies an available modulation scheme to the E-DCH by controlling the IL & CM 1718 and the modulator 1719 by means of control signals 1729 and 1730, respectively.

When time multiplexing, the PHY layer controller 1725 controls the switch 1717 by the control signal 1728 to switch the E-DCH data read from the HARQ buffer 1716 to the MUX 1731. The MUX 1731 time-multiplexes the DCH data and the E-DCH data. The time-multiplexed data is interleaved in an IL & CM 1732 and mapped to a corresponding physical channel frame, e.g., a DPDCH frame. The DPDCH frame is modulated in a modulator 1733, spread with a spreading code C_{d1} 1736 by a spreader 1747, multiplied by a channel gain 1738 in a channel gain adjuster 1739, and input to the channel summer 1769.

E-DCH control information including TFS-related information of the E-DCH is also transmitted according to the selected multiplexing scheme. Therefore, the multiplexing controller 1724 notifies a control information controller 1757 of the selected multiplexing scheme. The control information controller 1757 controls a DEMUX 1759 for receiving E-DCH control information 1756 according to the multiplexing scheme.

When code multiplexing, the control information controller 1757 controls the DEMUX 1759 by a control signal 1758 to output the E-DCH control information 1756 to an EU-DPCCH encoder 1760. The E-DCH control information encoded by the EU-DPCCH encoder 1760 is modulated in BPSK (Binary Phase Shift Keying) by a modulator 1761, spread with a spreading code Cₑ 1762 by a spreader 1763, multiplied by a channel gain 1764 by a channel gain adjuster 1765, and input to the channel summer 1769.

When time multiplexing, the control information controller 1757 controls the DEMUX 1759 by the control signal 1758 to output the E-DCH control information 1756 to a DPCCH encoder 1744. Although not shown, the DPCCH encoder 1744 has already received DCH control information. The DPCCH encoder 1744 encodes the DCH control information and the E-DCH control information. The coded DCH and E-DCH control information is modulated in BPSK by a modulator 1745, spread with a spreading code C_{c} 1746 by a spreader 1747, multiplied by a channel gain 1748 by a channel gain adjuster 1749, and input to the channel summer 1769. Because the EU-DPCCH encoder 1760 is not activated during time multiplexing, the control information controller 1757 activates a switch 1768 only for the code multiplexing, using control signal 1767.

Aside from the E-DCH and the DCH, an HS-DPCCH encoder 1750 encodes HS-DPCCH control information for an HSDPA service. The coded HS-DPCCH control information is modulated in BPSK by a modulator 1751, spread with a spreading code C_{HS} 1752 by a spreader 1753, multiplied by a channel gain 1754 by a channel gain adjuster 1755, and input to the channel summer 1769.

The channel summer 1769 sums all channel data, that is, the EU-DPCCH, DPCCH, HS-DPCCH, DPDCH and EU-DPDCH data. A scrambler 1770 scrambles the sum with a scrambling code S_{dpch,n}. An RF (Radio Frequency) 1772 processor converts the scrambled signal received through a pulse shaping filter 1771 to an RF signal, and transmits the RF signal through an antenna 1773.

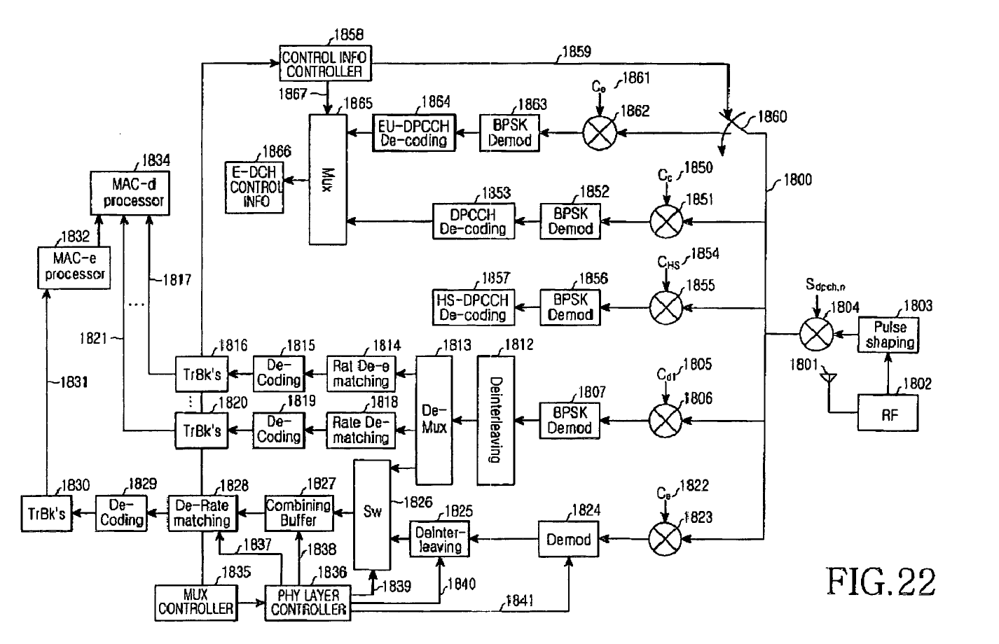

FIG. 22 is a block diagram of a receiver for selective demultiplexing in the Node B according to the preferred embodiment of the present invention. The receiver chooses either code demultiplexing or time demultiplexing to demultiplex the E-DCH and the DCH.

Referring to FIG. 22, an antenna 1801 receives an RF signal and an RF processor 802 and a pulse shaping filter 1803 convert the RF signal to a baseband signal. A scrambler 1804 extracts a signal 1800 received from the desired UE by multiplying the baseband signal by the scrambling code S_{dpch,n}.

To first decode the DCH, a despreader 1806 despreads the signal 1800 by multiplying it by a spreading code C_{d1} 1805 and a demodulator 1807 demodulates the despread signal in BPSK to a DCH coded bit stream. A deinterleaver 1812 deinterleaves the DCH coded bit stream and a DEMUX 1813 demultiplexes the deinterleaved signal into a plurality of transport channels.

Rate dematchers 1814 to 1818 rate-dematch the data of the respective transport channels and channel decoders 1815 to 1819 channel-decode the rate-dematched data. Transport block mappers 1816 to 1820 separate MAC-d PDUs 1817 to 1821 for the DCH from the channel-decoded DCH transport blocks and provide them to a MAC-d processor 1834.

The DEMUX 1813 separates E-DCH data from the time-multiplexed E-DCH and DCH data. If the time multiplexing is not used, the DEMUX 1813 does not output the E-DCH data. A switch 1826 switches one of the outputs of the DEMUX 1813 and a deinterleaver 1825 for the E-DCH in response to a control signal 1839 from a PHY layer controller 1836.

A multiplexing controller 1835 determines the multiplexing scheme of the E-DCH and the DCH and notifies a PHY layer controller 1836 of the determined multiplexing scheme. For example, the multiplexing controller 1835 determines whether the UE is in an SHO situation based on SHO indication information (e.g., active set) about the UE received from the SRNC. If the UE is in the SHO situation, the multiplexing controller 1835 determines that the E-DCH and the DCH were time-multiplexed. If the UE is not in a non-SHO situation, the multiplexing controller 1835 determines that the E-DCH and the DCH were code-multiplexed. If the E-DCH and the DCH were not multiplexed, the multiplexing controller 1835 selects the code multiplexing. The PHY layer controller 1836 controls a rate dematcher 1828 and a combining buffer 1827 by control signals 1837 and 1838, respectively, such that an appropriate operation is performed according to the determined multiplexing scheme.

When time multiplexing, the switch 1826 switches the E-DCH data from the DEMUX 1813 to the combining buffer 1827 in response to the control signal 1839 received from the PHY layer controller 1836. The combining buffer 1827 combines the same packet data received by HARQ and buffers them. The buffered packet data are converted to E-DCH transport blocks through rate dematching in the rate dematcher 1828 and channel decoding in a channel decoder 1829. A transport block mapper 1830 maps the channel-decoded E-DCH transport blocks to at least one MAC-e PDU for the E-DCH 1831. A MAC-e processor 1832 removes a MAC-e header from the MAC-e PDU and provides the resulting MAC-d PDUs for the E-DCH to the MAC-d processor 1834.

When code multiplexing, a despreader 1823 despreads the signal 1800 with an E-DCH spreading code Cₑ 1822, different from that of the DCH. The despread E-DCH signal is demodulated in a corresponding demodulation scheme in a demodulator 1824 and provided to the switch 1826 through a deinterleaver 1825. The demodulator 1824 and the deinterleaver 1825 operate according to the TF of the E-DCH in response to control signals 1840 and 1841, respectively, from the PHY layer controller 1836.

The switch 1826 switches the deinterleaved data to the combining buffer 1827 in response to the control signal 1839. The output of the combining buffer 1827 is converted to E-DCH transport blocks through rate-dematching in the rate dematcher 1828 and channel decoding in the channel decoder 1829. The transport block mapper 1830 maps the E-DCH transport blocks to at least one MAC-e PDU 1831 for the E-DCH. The MAC-e processor 1832 removes the MAC-e header from the MAC-e PDU 1831 and provides the resulting MAC-d PDUs for the E-DCH to the MAC-d processor 1834.

As described above, the operation of the receiver is controlled according to the multiplexing scheme of the E-DCH and the DCH.

Further, E-DCH control information 1866 including the TFS-related information of the E-DCH is received according to the multiplexing scheme. A control information controller 1858 controls a MUX 1865 for outputting the E-DCH control information 1866 and a switch 1860 for selecting one of the EU-DPCCH and the DPCCH by means of control signals 1867 and 1859.

When time multiplexing, the received signal 1800 is despread with a spreading code C_{c} 1850 in a despreader 1851 and demodulated in a demodulator 1852. A DPCCH decoder 1853 decodes the demodulated data and outputs DPCCH data. The MUX 1865 selects the E-DCH control information 1866 and outputs it in response to the control signal 1867. The switch 1860 is deactivated by means of the control signal 1859.

When code multiplexing, the switch 1860 is activated. The received signal 1800 is despread with a spreading code Cₑ 1861 in a despreader 1862 and demodulated in a demodulator 1863. An EU-DPCCH decoder 1864 decodes the demodulated data and outputs EU-DPCCH data. The MUX 1865 outputs the EU-DPCCH data as the E-DCH control information 1866 by the control signal 1867.

The received signal 1800 is despread with a spreading code CHS 1854 in a despreader 1855 and demodulated in a demodulator 1856. An HS-DPCCH decoder 1857 decodes the demodulated data and outputs HS-DPCCH data, i.e., HSDPA control information.

As described above, in the embodiments of the present invention, the UE multiplexes the E-DCH and the DCH, and transmits the multiplexed signal to a plurality of Node Bs in an SHO. The Node Bs demultiplex the E-DCH and the DCH. When some of Node Bs associated with the SHO are legacy Node Bs, i.e., Node Bs not supporting E-DCH, they also receive E-DCH data and DCH data using the TFS-related information of the DCH. This is possible because the E-DCH and the DCH share the same TFS-related information. The legacy Node Bs consider that the E-DCH data is DCH data and thus, do not support the HARQ functionality. The HARQ functionality refers to combining of previous failed data and retransmitted data. Also, when the UE transmits only the E-DCH data, the legacy Node Bs receive the E-DCH data using the TFS-related information of the DCH.

An E-DCH PHY layer structure differs from a DCH PHY layer structure in that a HARQ buffer and a soft-combining buffer are used to support the HARQ functionality. The HARQ buffer stores rate-matched coded bits. Upon receiving a NACK signal, the HARQ buffer outputs corresponding coded bits. Upon receiving an ACK signal, the HARQ buffer deletes the buffered coded bits and stores new coded bits instead. The soft-combining buffer stores deinterleaved coded bits, combines coded bits received after transmission of the NACK signal with previous coded bits, and stores the combined coded bits. After transmitting the ACK signal, the soft-combining buffer outputs the buffered coded bits.

When a UE establishes E-DCHs with a plurality of Node Bs in an SHO region and transmits E-DCH data to them, a legacy Node B that does not support the E-DCH decodes the E-DCH data using the TFCS of the DCH in the same manner as the DCH. However, an enhanced Node B, i.e., a Node B supporting the E-DCH, achieves an additional combining gain by soft-combining previous received coded bits with current received coded bits at a retransmission.

For better understanding of the present invention, a HARQ operation for the E-DCH in the SHO region will be described below.

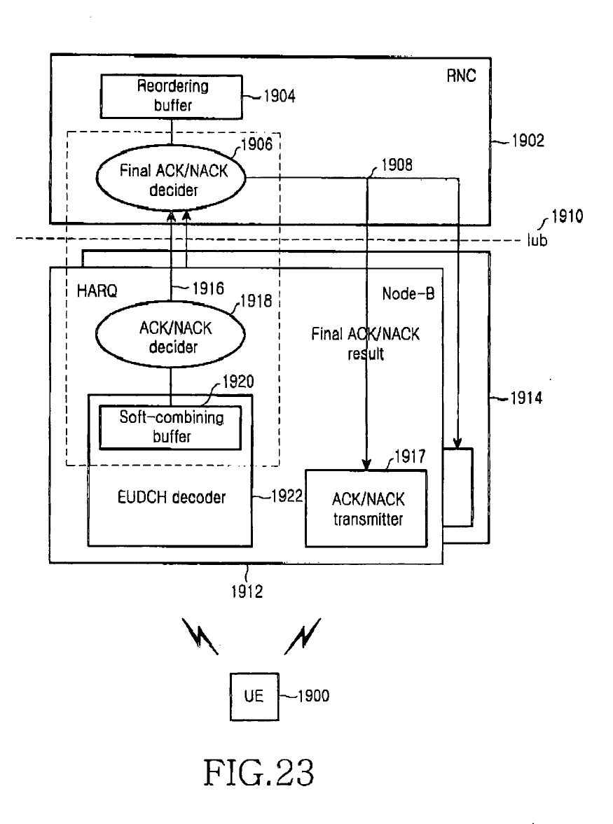

FIG. 23 illustrates a HARQ operation between an RNC and Node Bs communicating with one UE at an SHO according to a preferred embodiment of the present invention. Referring to FIG. 23, a UE 1900 is located in an SHO region where it is capable of receiving signals from two Node Bs 1912 and 1914. The active set of the UE 1900 has the PN (Pseudo-random Noise) offsets of pilot signals from the Node Bs 1912 and 1914. The Node Bs 1912 and 1914 are connected to an RNC 1902 by an lub interface 1910. Both the Node Bs 1912 and 1914 support the E-DCH and receive E-DCH data in the same reception procedure. Therefore, only the operation of the Node B 1912 will be described by way of example.

The Node B 1912 decodes E-DCH data through an E-DCH decoder 1922. The decoder 1922 is provided with a soft-combining buffer 1920 for supporting HARQ. At a retransmission, the soft-combining buffer 1920 soft-combines previous buffered data with new received data.

An ACK/NACK decider 1918 determines if the decoding is successful by checking the CRC of the decoded E-DCH data and decides whether to transmit an ACK or NACK signal based on the determination result. If the decoding is successful, the ANC/NACK decider 1918 decides to transmit the ACK signal. If the decoding is failed, the ANC/NACK decider 1918 decides to transmit the NACK signal. The ACK/NACK signal is transmitted in the form of frame protocol information to a final ACK/NACK decider 1906 of the RNC 1902 by an uplink lub interface 1916.

Because the UE 1900 is in the SHO situation, a plurality of ACK/NACK signals, that is, two ACKI/NACK signals in the illustrated case are generated from the Node Bs 1912 and 1914. The final ACK/NACK decider 1906 collects the ACK/NACK signals and determines final ACK/NACK signals. If there is at least one ACK among the ACK/NACK signals, the final ACK/NACK decider 1906 chooses an ACK signal. If the ACK/NACK signals are all NACK signals, the final ACK/NACK decider 1906 chooses a NACK signal. The final ACK/NACK signal is transmitted to the Node Bs 1912 and 1914 by a downlink lub interface 1908. An ACK/NACK transmitter 1917 of the Node B 1912 transmits the final ACK/NACK signal to the UE 1900.

The RNC 1902 determines whether each of the Node Bs associated with an SHO is a legacy Node B or an enhanced Node B, controls communications by the lub interface 1910, and transmits the final ACK/NACK signal to each Node B.

With a final ACK signal, the RNC 1902 receives E-DCH data from a corresponding Node B by a frame protocol. Because the order of E-DCH data units may be changed due to retransmissions, a reordering buffer 1904 reorders the data units in the original transmission order.

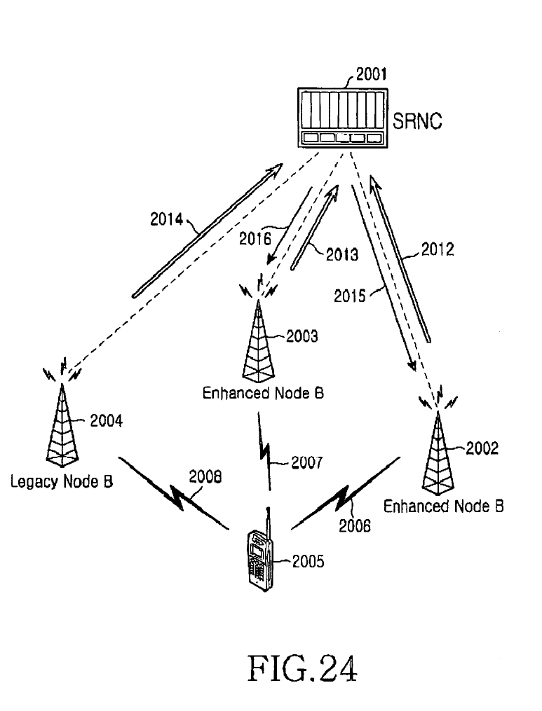

FIG. 24 conceptually illustrates an operation of a UE using an E-DCH in an SHO region between a legacy Node B and an enhanced Node B according to a preferred embodiment of the present invention. Referring to FIG. 24, reference numeral 2005 denotes a UE that transmits uplink data on the E-DCH and the DCH. Because the UE 2005 is located in an SHO region, its active set includes Node Bs 2002, 2003, and 2004. While the Node Bs 2002 and 2003 are enhanced Node Bs, the Node B 2004 is a legacy Node B that does not support the E-DCH. An SRNC 2001 controls communications of the UE 2005 through the Node Bs 2002, 2003, and 2004. The SRNC 2001 is connected to the Node Bs 2002, 2003, and 2004 directly by an lub interface, or by an lub interface or lur interface via a DRNC (Drift RNC). The lur interface is used for communications between RNCs.

The UE 2005 transmits uplink data 2006, 2007, and 2008 to the Node Bs 2002, 2003, and 2004. The uplink data 2006, 2007, and 2008 includes E-DCH and DCH data. The E-DCH and DCH data is transmitted based on the same TFS-related information. The DCH data is processed in the conventional procedure, which is beyond the scope of the present invention. Therefore, a description of the DCH data is not provided here.

Transmission of a data stream on the E-DCH will be described separately herein below according to an initial transmission and a retransmission.

At an initial E-DCH transmission, each of the Node Bs 2002, 2003, and 2004 decodes received E-DCH data, determines if the decoding is successful by CRC-checking the E-DCH data, and transmits the decoded data and a CRCI (CRC Indicator, i.e., ACK/NACK signal) indicating a CRC check result to the SRNC 2001 by a frame protocol.

Reference numeral 2012 denotes a data stream that the Node B 2002 transmits to the SRNC 2001 by the frame protocol and reference numeral 2013 denotes a data stream that the Node B 2003 transmits to the SRNC 2001 by the frame protocol. The enhanced Node Bs 2002 and 2003 use a newly defined frame protocol for the E-DCH or an existing frame protocol for the DCH. Reference numeral 2014 denotes a data stream that the Node B 2004 transmits to the SRNC 2001 by the frame protocol.

The SRNC 2001 obtains the E-DCH data transmitted from the UE 2005 by reading the data streams received from the Node Bs 2002, 2003, and 2004. As described earlier with reference to FIG. 23, the SRNC 2001 decides a final ACK/NACK signal from ACK/NACK signals from the Node Bs 2002, 2003, and 2004. If at least one of the ACK/NACK signals is an ACK signal indicating a successful decoding, the SRNC 2001 chooses an ACK signal as a final ACK/NACK. If all of the ACK/NACK signals are NACK signals indicating failed decodings, the SRNC 2001 chooses an NACK signal as the final ACK/NACK.

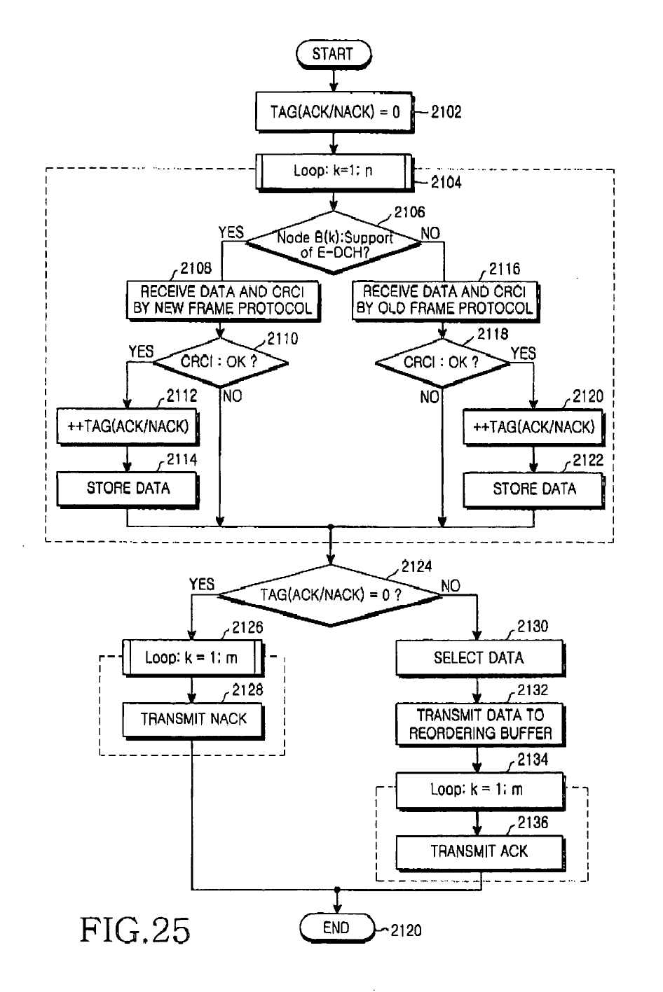

The final ACK/NACK signal is transmitted together with downlink data streams 2016 and 2017 to the enhanced Node Bs 2002 and 2003. The final ACK/NACK signal is transmitted only to the enhanced Node Bs 2002 and 2003 all the time, not to the legacy Node B 2004 because the legacy Node B 2004 does not support the HARQ functionality. The operation of the SRNC 2001 is depicted in detail in FIG. 25 and will be described in more detail later.

At an E-DCH retransmission, that is, when the SRNC 2001 chooses a NACK signal as the final ACK/NACK and the enhanced Node Bs 2002 and 2003 transmit the final NACK signal to the UE 2005, the legacy Node B 2004 decodes received E-DCH data in the same manner irrespective of an initial transmission or a retransmission. Because the enhanced Node Bs 2002 and 2003 know that the received E-DCH data is retransmission data, they soft-combine data stored in their soft-combining buffers with the received E-DCH data and decode the soft-combined data.

After the decoding, each of the Node Bs 2002, 2003, and 2004 determines if the decoding is successful and transmits the decoded data and a CRCI (i.e., an ACK/NACK signal) to the SRNC 2001 by the frame protocol. In the same manner ass described above, the SRNC 2001 processes the decoded data and the ACK/NACK signals.

FIG. 25 is a flowchart illustrating the HARQ support operation of the SRNC in detail according to the preferred embodiment of the present invention. The SRNC receives E-DCH data transmitted from a UE in an SHO region and ACK/NACK signals from n Node Bs included in the active set of the UE, and decides a final ACK/NACK signal for the data. Further, the SRNC refers to data received from a legacy Node B in deciding the final ACK/NACK signal.

Referring to FIG. 25, the SRNC sets TAG(ACK/NACK) to an initial value 0 in step 2102. The TAG(ACK/NACK) is used for the SRNC to decide the final ACK/NACK signal, and is set to a value other than 0 if at least one of the Node Bs of the active set transmits an ACK signal. In step 2104, the SRNC runs a loop (steps 2106 through 2122) for each of the n Node Bs that receive E-DCH data from the UE. In each loop, the SRNC receives received E-DCH data and an ACK/NACK signal from each of the Node Bs. Accordingly, the loop runs n times.

For a k^{th} loop (1≦k≦n), the SRNC checks the version of a k^{th} Node B to determine if the k^{th} Node B supports the E-DCH. Because the SRNC already knows the version of every Node B, it checks the versions of the Node Bs connected to the UE. If the k^{th} Node B is an enhanced Node B supporting the E-DCH, the SRNC proceeds to step 2108. If the k^{th} Node B is a legacy Node B that does not support the E-DCH, the SRNC proceeds to step 2116.

The SRNC receives a data stream and a CRCI from the enhanced Node B by a corresponding frame protocol in step 2108 and determines from the CRCI whether the data stream has been successfully decoded in step 2110. If the data stream has been successfully decoded, i.e., CRCI indicates “Yes”, the SRNC increments the TAG(ACK/NACK) by 1 in step 2112 and stores the data stream in a buffer on an lub interface between the SRNC and the Node Bs in step 2114. Then, the SRNC runs the loop for the next Node B. However, if the data stream is not successfully decoded, i.e., the CRCI indicates “No” in step 2110, the SRNC runs the loop for the next Node B.

In step 2116, the SRNC receives a data stream and a CRCI from the legacy Node B by a corresponding frame protocol. The SRNC determines by the CRCI if the data stream has been successfully decoded in step 2118. If the data stream has been successfully decoded, i.e., the CRCI indicates “Yes”, the SRNC increments the TAG(ACK/NACK) by 1 in step 2120 and stores the data stream in the buffer in step 2122. Then, the SRNC runs the loop for the next Node B. However, if the data stream has not been successfully decoded, i.e., the CRCI indicates “No” in step 2118, the SRNC runs the loop for the next Node B.

In steps 2108 and 2116, the SRNC receives the data stream from the Node B by a different frame protocol depending on the version of the Node B, that is, depending on whether the Node B supports the E-DCH or not.

When the loop has run completely for all the Node Bs at the SHO, the SRNC determines if the TAG(ACK/NACK) is 0 in order to decide the final ACK/NACK signal in step 2124. If at least one ACK signal is detected in the n loops, that is, if the TAG(ACK/NACK) is not 0, the SRNC proceeds to step 2130.

In step 2130, the SRNC selects one of the buffered data. If only one data is stored, in other words, if error-free decoded data has been received from only one Node B, the data is selected. The selected data is provided to the reordering buffer in step 2132. The reordering buffer reorders the data in the original transmission order. The SRNC runs a loop m times for m enhanced Node Bs in step 2134. In the loops, the SRNC transmits a final ACK signal to the enhanced Node Bs. That is, the SRNC transmits the final ACK signal to each of the enhanced Node Bs in step 2136. The ACK signal is provided to the UE through the enhanced Node Bs.

However, if decoding errors are generated in all the Node Bs, that is, if the TAG(ACK/NACK) is 0 in step 2124, the SRNC proceeds to step 2126. The SRNC runs the loop m times for the m enhanced Node Bs in step 2126. In the loops, the SRNC transmits a final NACK signal to the enhanced Node Bs. That is, the SRNC transmits the final NACK signal to each of the enhanced Node Bs in step 2128. The NACK signal is provided to the UE through the enhanced Node Bs.

In the preferred embodiment of the present invention, the SRNC supporting the HARQ functionality of the E-DCH decides the final ACK/NACK signal referring to error information from legacy Node Bs and enhanced Node Bs, and transmits the final ACK/NACK signal to the enhanced Node Bs all the time.

The major effects of the present invention described above are summarized as follows.

A multiplexing scheme for the E-DCH and the DCH is chosen taking the channel status of a UE into account in an asynchronous WCDMA communication system using the E-DCH. Therefore, the total performance of the E-DCH is increased.

The present invention configures a common TFCS for the E-DCH and the DCH and provides a method of delivering the TFS-related information to a Node B and a UE. Therefore, transmission/reception of the E-DCH is enabled for the Node B and the UE, while minimizing additional functions in E-DCH using systems. As a result, the increase of complexity and cost caused by addition of required functions is minimized.

Furthermore, a legacy Node B is also enabled to decode E-DCH data using common TFS-related information. Therefore, a macro diversity gain achieved in an RNC is maximized even when a UE communicates with both a legacy Node B and an enhanced Node B. Uplink reception performance is improved, thereby improving system performance and reducing additional cost.

While the present invention has been shown and described with reference to certain preferred embodiments thereof, it will be understood by those skilled in the art that various changes in form and details may be made therein without departing from the spirit and scope of the present invention as defined by the appended claims.

1. A method of multiplexing a first dedicated channel and a second dedicated channel for an uplink packet data service, the second dedicated channel being enhanced from the first dedicated channel, in an asynchronous wideband code division multiple access (WCDMA) communication system, the method comprising the steps of:
determining an uplink channel status in which the first and second dedicated channels are used;
configuring a physical layer code-multiplexing structure for code-multiplexing the first and second dedicated channels in a user equipment (UE) that implements the uplink packet data service, if the uplink channel status meets a predetermined criteria; and
configuring a physical layer time-multiplexing structure for time-multiplexing the first and second dedicated channel in the UE, if the uplink channel status does not meet the predetermined criteria.

2. The method of claim 1, wherein the uplink channel status does not meet the predetermined criteria if the UE is located in a soft handover region in which it receives signals from at least two Node Bs.

3. The method of claim 2, wherein the step of determining the uplink channel status comprises the steps of:
receiving from a radio network controller (RNC) an active set including a list of at least one Node B communicating with the UE; and
determining that the UE is located in the soft handover region if at least two Node Bs are included in the active set.

4. The method of claim 1, further comprising the steps of:
configuring common transport format set (TFS)-related information indicating transport formats (TFs) available to transport blocks transmitted on the first and second dedicated channels; and
providing the TFS-related information to the UE and at least one Node B.

5. The method of claim 4, wherein the TFS-related information transmitted to the UE indicates a size of an upper-layer data unit included in each transport block of the first dedicated channel, a number of the transport blocks of the second dedicated channel, and a number of transport blocks of the first dedicated channel per transport block of the second dedicated channel, and wherein a transport block of the second dedicated channel is identical to a data unit of the second dedicated channel and includes a second dedicated channel header and a plurality of transport blocks of the first dedicated channel.

6. The method of claim 5, wherein the TFS-related information transmitted to the at least one Node B includes a size and a number of the transport blocks of the second dedicated channel, the size of the transport blocks of the second dedicated channel being the product of the size and the number of the transport blocks of the first dedicated channel, and the number of the transport blocks of the second dedicated channel being 1.

7. The method of claim 5, wherein the TFS-related information transmitted to the at least one Node B includes a size of the transport blocks of the first dedicated channel and the number of transport blocks of the first dedicated channel per transport block of the second dedicated channel.

8. The method of claim 4, wherein the TFS-related information transmitted to the UE includes a size of an upper-layer data unit included in each transport block of the first dedicated channel and a number of transport blocks of the first dedicated channel per data unit of the second dedicated channel, a data unit of the second dedicated channel including a plurality of transport blocks of the second dedicated channel, and each transport block of the second dedicated channel having a second dedicated channel header and a transport block of the first dedicated channel.

9. The method of claim 8, wherein the TFS-related information transmitted to the at least one Node B includes a size and a number of the transport blocks of the second dedicated channel, a size of the transport blocks of the second dedicated channel being a sum of the size of the transport blocks of the first dedicated channel and the size of the second dedicated channel header, and the number of the transport blocks of the second dedicated channel being equal to the number of the transport blocks of the first dedicated channel.

10. The method of claim 8, wherein the TFS-related information transmitted to the at least one Node B includes the size of the transport blocks of the first dedicated channel and the number of transport blocks of the first dedicated channel per data unit of the second dedicated channel.

11. The method of claim 4, wherein the TFS-related information transmitted to the UE includes a size of an upper-layer data unit included in each transport block of the first dedicated channel and a number of transport blocks of the first dedicated channel per data unit of the second dedicated channel, a data unit of the second dedicated channel being identical to a transport block of the second dedicated channel, and the transport block of the second dedicated channel having a second dedicated channel header and a transport block of the first dedicated channel.

12. The method of claim 11, wherein the TFS-related information transmitted to the at least one Node B includes a size and a number of the transport blocks of the second dedicated channel, the size of the transport blocks of the second dedicated channel being a sum of the size of the transport blocks of the first dedicated channel and the size of the second dedicated channel header, and the number of the transport blocks of the second dedicated channel being equal to the number of the transport blocks of the first dedicated channel.

13. The method of claim 11, wherein the TFS-related information transmitted to the at least one Node B includes the size of the transport blocks of the first dedicated channel and the number of transport blocks of the first dedicated channel per data unit of the second dedicated channel.

14. The method of claim 1, further comprising the step of code-multiplexing the first and second dedicated channels in the physical layer code-multiplexing structure, the code-multiplexing step comprising:
channel-encoding a first data unit to be transmitted on the first dedicated channel;
interleaving the channel-coded first data unit;
mapping the interleaved first data unit to a first code channel;
attaching a second dedicated channel header to a second data unit to be transmitted on the second dedicated channel;
channel-encoding the second data unit having the second dedicated channel header;
interleaving the channel-coded second data unit; and
mapping the interleaved second data unit to a second code channel having a different spreading code from a spreading code of the first code channel.

15. The method of claim 1, further comprising the step of time-multiplexing the first and second dedicated channels in the physical layer time-multiplexing structure, the time-multiplexing step comprising:
channel-encoding a first data unit to be transmitted on the first dedicated channel;
attaching a second dedicated channel header to a second data unit to be transmitted on the second dedicated channel;
channel-encoding the second data unit having the second dedicated channel header;
time-multiplexing the channel-coded first and second data units;
interleaving the time-multiplexed data unit; and
mapping the interleaved data unit to a code channel.

16. The method of claim 1, further comprising the steps of:
configuring a physical layer code-demultiplexing structure for code-demultiplexing the first and second dedicated channel received from the UE in at least one Node B communicating with the UE, if the uplink channel status meets the predetermined criteria; and
configuring a physical layer time-demultiplexing structure for time-demultiplexing the first and second dedicated channel received from the UE in the at least one Node B, if the uplink channel status is does not meet the predetermined criteria.

17. The method of claim 16, further comprising the step of code-demultiplexing the first and second dedicated channels in the physical layer code-demultiplexing structure, the code-demultiplexing step comprising:
acquiring transport blocks of the first dedicated channel by spreading a signal received from the UE with a first spreading code assigned to the first dedicated channel and decoding the despread first dedicated channel signal; and
acquiring transport blocks of the second dedicated channel by spreading the received signal with a second spreading code assigned to the second dedicated channel and decoding the despread second dedicated channel signal.

18. The method of claim 16, further comprising the step of time-demultiplexing the first and second dedicated channels in the physical layer time-demultiplexing structure, the time-demultiplexing step comprising:
despreading a signal received from the UE with a common spreading code for the first and second dedicated channels;
time-demultiplexing the despread signal into first dedicated channel data and second dedicated channel data; and
acquiring transport blocks of the first dedicated channel and transport blocks of the second dedicated channel by decoding the first and second dedicated channel data.

19. The method of claim 1, further comprising the steps of:
receiving data and error signals from at least two Node Bs communicating with the UE at a soft handover, the data being produced by demodulating a signal received from the UE, the error signals indicating if the data has any errors, and the at least two Node Bs including at least one legacy Node B that does not support the second dedicated channel and at least one enhanced Node B that supports the second dedicated channel;
determining a response signal according to the error signals; and
transmitting the determined response signal to the at least one enhanced Node B.

20. The method of claim 19, wherein the response signal is determined to be an acknowledgement (ACK) signal, if the error signals include at least one ACK signal, and determined to be a negative acknowledgement (NACK) signal, if the error signals are all NACK signals.

21. An apparatus in a user equipment (UE) for multiplexing a first dedicated channel and a second dedicated channel for an uplink packet data service, the second dedicated channel being enhanced from the first dedicated channel, in an asynchronous wideband code division multiple access (WCDMA) communication system, comprising:
a multiplexing controller for determining an uplink channel status in which the first and second dedicated channels are used, and outputting a control signal according to the determined uplink channel status;
a first channel encoder for attaching error detection information to a first data unit to be transmitted on the first dedicated channel, and channel-encoding the first data unit having the error detection information;
a second channel encoder for attaching error detection information to a second data unit to be transmitted on the second dedicated channel, and channel-encoding the second data unit having the error detection information;
a switch for switching the channel-coded second data unit to a first output according to the control signal if the uplink channel status meets a predetermined criteria, and switching the channel-coded second data unit to a second output according to the control signal if the uplink channel status does not meet the predetermined criteria;
a time multiplexer for time-multiplexing the channel-coded first data unit with the channel-coded second data unit received from the second output of the switch;
a first spreader for spreading the time-multiplexed data with a first spreading code; and
a second spreader for spreading the channel-coded second data unit received from the first output of the switch.

22. The apparatus of claim 21, wherein the uplink channel status does not meet the predetermined criteria, if the UE is located in a soft handover region in which the UE receives signals from at least two Node Bs.

23. The apparatus of claim 22, wherein the multiplexing controller receives from a radio network controller (RNC) for controlling the uplink packet data service an active set including a list of at least one Node B communicating with the UE, and determines that the UE is located in the soft handover region if at least two Node Bs are included in the active set.

24. An apparatus in a Node B for demultiplexing a first dedicated channel and a second dedicated channel for an uplink packet data service, received from a user equipment (UE) in an asynchronous wideband code division multiple access (WCDMA) communication system, comprising:
a multiplexing controller for determining the uplink channel status of the UE in which the first and second dedicated channels are used and outputting a control signal according to the determined uplink channel status;
a first despreader for despreading a signal received from the UE with a first spreading code;
a second despreader for despreading the received signal with a second spreading code;
a demultiplexer for time-demultiplexing the output of the first spreader;
a switch for selecting the output of the demultiplexer according to the control signal if the uplink channel status meets a predetermined criteria, and selecting the output of the second despreader according to the control signal if the uplink channel status does not meet the predetermined criteria;
a first channel decoder for decoding the output of the demultiplexer and outputting transport blocks of the first dedicated channel; and
a second channel decoder for decoding the output of the switch and outputting transport blocks of the second dedicated channel.

25. The apparatus of claim 24, wherein the multiplexing controller receives soft handover indication information about the UE from a radio network controller (RNC) for controlling the uplink packet data service, and determines that the uplink channel status does not meet the predetermined criteria, if the soft handover indication information indicates a presence of the UE in a soft handover region in which the UE receives signals from at least two Node Bs.

26. A method of establishing a first dedicated channel and a second dedicated channel for an uplink packet data service, the second dedicated channel being enhanced from the first dedicated channel, in an asynchronous wideband code division multiple access (WCDMA) communication system, the method comprising the steps of:
configuring common transport format set (TFS)-related information indicating transport formats (TFs) available to transport blocks transmitted on the first and second dedicated channels; and
providing the TFS-related information to a UE that implements the uplink packet data service, and at least one Node B.

27. The method of claim 26, wherein the TFS-related information transmitted to the UE includes a size of an upper-layer data unit included in each transport block of the first dedicated channel, a number of transport blocks of the second dedicated channel, and a number of transport blocks of the first dedicated channel per transport block of the second dedicated channel, a transport block of the second dedicated channel being identical to a data unit of the second dedicated channel and including a second dedicated channel header and a plurality of transport blocks of the first dedicated channel.

28. The method of claim 27, wherein the TFS-related information transmitted to the at least one Node B includes a size and a number of the transport blocks of the second dedicated channel, the size of the transport blocks of the second dedicated channel being the product of the size and the number of the transport blocks of the first dedicated channel, and the number of the transport blocks of the second dedicated channel being 1.

29. The method of claim 27, wherein the TFS-related information transmitted to the at least one Node B includes the size of the transport blocks of the first dedicated channel and the number of transport blocks of the first dedicated channel per transport block of the second dedicated channel.

30. The method of claim 26, wherein the TFS-related information transmitted to the UE includes a size of an upper-layer data unit included in each transport block of the first dedicated channel and a number of transport blocks of the first dedicated channel per data unit of the second dedicated channel, a data unit of the second dedicated channel including a plurality of transport blocks of the second dedicated channel, and each transport block of the second dedicated channel having a second dedicated channel header and a transport block of the first dedicated channel.

31. The method of claim 30, wherein the TFS-related information transmitted to the at least one Node B includes a size and a number of the transport blocks of the second dedicated channel, the size of the transport blocks of the second dedicated channel being a sum of the size of the transport blocks of the first dedicated channel and the size of the second dedicated channel header, and the number of the transport blocks of the second dedicated channel being equal to the number of the transport blocks of the first dedicated channel.

32. The method of claim 30, wherein the TFS-related information transmitted to the at least one Node B includes the size of the transport blocks of the first dedicated channel and the number of transport blocks of the first dedicated channel per data unit of the second dedicated channel.

33. The method of claim 26, wherein the TFS-related information transmitted to the UE includes a size of an upper-layer data unit included in each transport block of the first dedicated channel and a number of transport blocks of the first dedicated channel per data unit of the second dedicated channel, a data unit of the second dedicated channel being identical to a transport block of the second dedicated channel, and the transport block of the second dedicated channel having a second dedicated channel header and a transport block of the first dedicated channel.

34. The method of claim 33, wherein the TFS-related information transmitted to the at least one Node B includes the size and number of the transport blocks of the second dedicated channel, the size of the transport blocks of the second dedicated channel being a sum of the size of the transport blocks of the first dedicated channel and the size of the second dedicated channel header, and the number of the transport blocks of the second dedicated channel being equal to the number of the transport blocks of the first dedicated channel.

35. The method of claim 33, wherein the TFS-related information transmitted to the at least one Node B includes the size of the transport blocks of the first dedicated channel and the number of transport blocks of the first dedicated channel per data unit of the second dedicated channel.

36. A hybrid automatic retransmission request (HARQ) method for a second dedicated channel in an asynchronous wideband code division multiple access (WCDMA) communication system in which a first dedicated channel and the second dedicated channel are used for an uplink packet data service, the second dedicated channel being enhanced from the first dedicated channel, the method comprising the steps of:
receiving data and error signals from at least two Node Bs communicating with a UE that implements the uplink data service by a soft handover, the data being produced by demodulating a signal received from the UE, the error signals indicating if the data has any errors, and the at least two Node Bs including at least one legacy Node B that does not support the second dedicated channel and at least one enhanced Node B that supports the second dedicated channel;
determining a response signal according to the error signals; and
transmitting the determined response signal to the at least one enhanced Node B.

37. The HARQ method of claim 36, wherein the response signal is determined to be an acknowledgement (ACK) signal, if the error signals include at least one ACK signal, and is determined to be a negative acknowledgement (NACK) signal, if the error signals are all NACK signals.

38. The HARQ method of claim 37, further comprising the steps of:
selecting, if the error signals include the at least one ACK signal, one of at least one data corresponding to the at least one ACK signal; and
reordering the selected data together with previous received data in an original transmission order.

39. A radio network controller (RNC) for supporting hybrid automatic retransmission request (HARQ) of a second dedicated channel in an asynchronous wideband code division multiple access (WCDMA) communication system in which a first dedicated channel and the second dedicated channel are used for an uplink packet data service, the second dedicated channel being enhanced from the first dedicated channel, the RNC comprising:
a final response decider for receiving data and error signals from at least two Node Bs communicating with a UE that implements the uplink data service by a soft handover, the data being produced by demodulating a signal received from the UE and the error signals indicating if the data has errors, and the at least two Node Bs including at least one legacy Node B that does not support the second dedicated channel and at least one enhanced Node B that supports the second dedicated channel, and determining a response signal according to the error signals; and
a transmitter for transmitting the determined response signal to the at least one enhanced Node B.

40. The RNC of claim 39, wherein the final response decider determines the response signal to be an acknowledgement (ACK) signal, if the error signals include at least one ACK signal, and determines the response signal to be a negative acknowledgement (NACK) signal, if the error signals are all NACK signals.

41. The RNC of claim 39, further comprising a reodering buffer for selecting, if the error signals include at least one acknowledgement (ACK) signal, one of at least one data corresponding to the at least one ACK signal, and reordering the selected data together with previous received data in an original transmission order.
